(19) United States
(12) Patent Application Publication
(10) Pub. No.: US 2025/0265390 A1
(43) Pub. Date: Aug. 21, 2025

(54) SOLID STATE BATTERIES AND METHODS OF DESIGNING AND MAKING THEREOF

(71) Applicants: LG Energy Solution, Ltd., Seoul (KR); The Regents of the University of California, Oakland, CA (US)

(72) Inventors: Jiyoung Kim, Daejeon (KR); Jung-Pil Lee, Daejeon (KR); Charles Mish, La Jolla, CA (US); Hyunsun Alicia Kim, La Jolla, CA (US)

(21) Appl. No.: 19/048,171

(22) Filed: Feb. 7, 2025

Related U.S. Application Data
(60) Provisional application No. 63/554,110, filed on Feb. 15, 2024.

(51) Int. Cl. G06F 30/25; G06F 111/10

(52) U.S. Cl. CPC G06F 30/25; G06F 2111/10

(57) ABSTRACT

The present disclosure provides methods of designing and making all-solid-state batteries. A set of input data is provided to produce a simulation box containing electrode active material particles and solid electrolyte particles in randomly selected discretized spaces. A compressed simulation box is then generated, such that each of the particles touches at least one neighboring particle. The compressed simulation box data is processed to obtain a relative tortuosity of the SE particles. The steps are repeated to prepare a database comprising sets of input parameters and corresponding relative tortuosities. A desired set of input parameters is selected from the database, and an all-solid-state lithium battery is prepared accordingly.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

The present disclosure relates to solid state batteries and methods of making solid state batterie.

### Secondary Batteries

Secondary batteries have become increasingly desirable power sources for a wide range of various electronic devices, such as cars, computers, cell phones, tools, scooter, bikes, electronic automobiles, power storage systems, drones, and other devices. Among secondary batteries, lithium-based batteries have gained particular prominence due to their ability to provide a desirable balance of voltage and energy density. In addition to their performance advantages, lithium ion secondary batteries contribute to addressing climate change by enabling the electrification of transportation and facilitating the integration of renewable energy sources. These batteries help reduce greenhouse gas emissions by powering electric vehicles and storing energy from intermittent renewable sources like solar and wind. Furthermore, the long cycle life and high energy density of lithium ion batteries may support the development of smart grids and decentralized energy systems, potentially improving overall energy efficiency and reducing reliance on fossil fuels. Traditionally, lithium secondary batteries include a liquid electrolyte, typically comprising a lithium salt dissolved in an organic solvent. However, there has been growing interest in developing an all solid-state lithium secondary battery as an alternative to conventional liquid electrolyte-based systems. Solid-state batteries offer potential advantages in terms of safety, stability, and energy density. Despite these potential benefits, the development of practical all solid-state lithium secondary batteries faces several significant challenges.

### Challenges of all Solid-State Secondary Batteries

One challenge in solid-state battery design is achieving and maintaining sufficient lithium ion diffusivity within the solid electrolyte material. Further, volume changes (e.g. swelling and shrinking) of certain components of the battery—such as the electrode—may occur during discharging and charging of the battery. These volume changes may lead to mechanical stress or result in a loss of contact between various components within the battery structure. The loss of contact between battery components can cause degradation of charging and discharging characteristics, as well as deterioration of overall battery capacity. Researchers and engineers in the field of energy storage are actively working to address these challenges. Efforts are focused on developing new materials and battery designs that can achieve desirable lithium ion diffusivity while also accommodating the mechanical stresses associated with battery cycling. Improving the stability of interfaces within solid-state batteries remains an area of investigation. Overcoming the current limitations of solid-state battery systems could potentially lead to significant advancements in energy storage capabilities for a wide range of applications.

Since lithium metal or lithium alloy can be used as the cathode material, there is an advantage in dramatically improving the energy density relative to the mass and volume of the battery. However, although the theoretical energy density of a solid-state battery is predicted to be 10 to 20% higher than that of existing lithium-ion batteries, there are various problems in actually making such cells. In particular, the cathode electrode usually includes a positive electrode active material, a solid electrolyte, a conductive material, and a binder. To develop capacity, the contact area between the solid electrolyte and the positive electrode active material must be increased to primarily maximize the transfer of lithium ions. To achieve this, research must be conducted first to optimize the particle size and ratio of the positive electrode active material and solid electrolyte. The optimal anode structure can be obtained experimentally, but there are limits to finding all combinations experimentally.

### No Admission of Prior Art

The discussion in this section is intended to provide background information related to the present disclosure and does not constitute an admission of prior art.

### SUMMARY

The present disclosure provides methods for optimizing the electrode structure through modeling and making an all-solid-state battery accordingly.

One aspect of the present disclosure provides a method of making an all-solid-state lithium battery. First, a set of input parameters is provided, including a weight percentage (SE_wt %) and a density (SE_density) of a solid electrolyte material (SE) comprising spherical SE particles, and a weight percentage (EAM_wt %) and a density (EAM_density) of an electrode active material (EAM) comprising spherical EAM particles.

Then, a volume percentage (EAM_vol) of the EAM and a volume percentage (SE_vol) of the SE are provided as follows: EAM_vol=(EAM_wt %/EAM_density)/(EAM_wt %/EAM_density+SE_wt %/SE_density), SE_vol=(SE_wt %/SE_density)/(EAM_wt %/EAM_density+SE_wt %/SE_density). A probability value of the EAM is provided as follows: (EAM_vol/EAM_pvol)/(EAM_vol/EAM_pvol+SE_vol/SE_pvol), wherein EAM_pvol is a mean volume of the spherical EAM particles, and SE_pvol is a mean volume of the spherical SE particles, the probability value representing a number of the spherical SE particles for each spherical EAM particle.

Further, the probability value of the EAM is used to produce simulation box data representing a simulation box divided into discretized spaces, and the simulation box contains the spherical EAM particles and the spherical SE particles in randomly selected discretized spaces, and the simulation box data indicates whether each discretized space is occupied by one of the spherical EAM particles or one of the spherical SE particles. The simulation box data is processed to produce compressed simulation box data representing that the simulation box is compressed along a vertical axis between the top and the bottom without being compressed in any other direction, such that each of spherical EAM particles and the spherical SE particles touches at least one neighboring particle. The compressed simulation box data is processed to produce adjacency matrix data representing connected spherical SE particles, each of the connected spherical SE particles touching or overlapping with at least one adjacent spherical SE particle.

A relative tortuosity of the spherical SE particles inside the compressed simulation box is obtained by processing the adjacency matrix data to produce path data identifying paths generally in a direction from the top to the bottom through centers of the connected spherical SE particles, each path extending from a top connected spherical SE particle to a bottom connected spherical SE particle, processing the path data to identify and store desired path data representing a desired path, and extracting length data representing a length of the desired path from a center of a top connected spherical SE particle on the desired path to a center of a bottom connected spherical SE particle on the desired path; extracting Euclidean distance data representing a Euclidean distance between the top connected spherical SE particle and the bottom connected spherical SE particle of the desired path; and processing the length of the desired path and the Euclidean distance to provide the relative tortuosity.

The above steps are repeated to prepare a database comprising sets of input parameters and corresponding relative tortuosities. A desired set of input parameters is selected from the database using the corresponding relative tortuosity.

The all-solid-state lithium battery is then prepared by using the desired set of input parameters.

In some embodiments, the set of input parameters further comprises one or more of particle size information of the spherical EAM particles, particle size information of the spherical SE particles, a weight percentage and a density of a carbon material, and a weight percentage and a density of a binder.

In some embodiments, the all-solid-state lithium battery comprises a first electrode, a second electrode, and an SE layer, the preparing the all-solid-state lithium battery comprising: preparing the first electrode using the desired set of input parameters; providing the second electrode; providing the carbon material and the binder using the desired set of input parameters; and preparing the SE layer using the desired set of input parameters.

In some embodiments, the particle size information of the spherical EAM particles comprises at least one of an average diameter or a particle size distribution of the spherical EAM particles.

In some embodiments, the particle size information of the spherical SE particles comprises at least one of an average diameter or a particle size distribution of the spherical SE particles.

In some embodiments, the set of input parameters comprises the particle size distribution of the spherical EAM particles and the particle size distribution of the spherical SE particles.

In some embodiments, size data representing sizes of the spherical EAM particles and the spherical SE particles in the simulation box is produced using the particle size distribution of the spherical EAM particles and the particle size distribution of the spherical SE particles.

In some embodiments, the particle size distribution of the spherical EAM particles and the particle size distribution of the spherical SE particles each are selected from the group consisting of normal, lognormal, skew normal, skew, and bimodal.

In some embodiments, the adjacency matrix data represents an adjacency matrix, wherein the adjacency matrix is a Z×Z matrix, and Z is the number of the spherical SE particles; the adjacency matrix data comprises a value of “1” in the adjacency matrix for each two adjacent spherical SE particles touching or overlapping with each other, wherein a sum of radii of the two adjacent spherical SE particles touching or overlapping with each other is equal to or greater than an overlap criterion; and the adjacency matrix data comprises a value of “0” in the adjacency matrix for each two adjacent spherical SE particles not touching or overlapping with each other, wherein a sum of radii of the two adjacent spherical SE particles not touching or overlapping with each other is smaller than the overlap criterion.

In some embodiments, the overlap criterion is 100% to 105% of the Euclidean distance between the two adjacent spherical SE particles touching or overlapping with each other.

In some embodiments, the overlap criterion is 102% of the Euclidean distance between the two adjacent spherical SE particles touching or overlapping with each other.

In some embodiments, the set of input parameters comprises an additional input parameter selected from the group consisting of at least one of Young's Modulus, Poisson's Ratio, Friction Coefficient, or Coefficient of Restitution of the SE material; at least one of Young's Modulus, Poisson's Ratio, Friction Coefficient, or Coefficient of Restitution of the EAM; a size of the simulation box; a number of particles per edge of the simulation box; and combinations thereof.

In some embodiments, the processing the simulation box data to produce the compressed simulation box data comprises processing pressure data representing a pre-determined pressure applied to the simulation box.

In some embodiments, a total force applied to the simulation box is calculated by multiplying the pre-determined pressure by a cross-sectional area of the simulation box.

In some embodiments, a force-per-particle is calculated by dividing the total force into a first force on all the spherical EAM particles and a second force on all the spherical SE particles as follows: the first force=the total force x EAM_vol, the second force=the total force x SE_vol; dividing the first force by a total number of the spherical EAM particles, and dividing the second force by a total number of the spherical SE particles.

In some embodiments, the EAM is a cathode active material.

In some embodiments, at least one of porosity of the first electrode, EAM utilization, or SE utilization is calculated.

In some embodiments, the EAM utilization is calculated by processing the adjacency matrix data to produce base SE data representing base connected spherical SE particles, wherein each of the base connected spherical SE particles touches or overlaps with an adjacent base connected SE particle, and at least one of the base connected spherical SE particles touches the bottom of the simulation box; processing the adjacency matrix data to produce EAM data representing connected spherical EAM particles, wherein each of the connected spherical EAM particles touches at least one of the base connected spherical SE particles; processing the EAM data to produce first volume data representing a total volume of the connected spherical EAM particles; processing the simulation box data to produce second volume data representing a total volume of all the spherical EAM particles; and dividing the total volume of the connected spherical EAM particles by the total volume of all the spherical EAM particles.

In some embodiments, porosity of the first electrode is calculated by calculating a total volume of the first electrode by multiplying a pre-determined height of the simulation box by a cross-sectional area of the simulation box; calculating a total volume of solids in the first electrode by adding a volume of the EAM and a volume of the SE material; calculating a volume of voids by subtracting the total volume of solids from the total volume of the first electrode; and dividing the volume of voids by the total volume of the first electrode.

Another aspect of the present disclosure is an all-solid-state battery made by the method provided herein. Yet another aspect of the present disclosure is an electric vehicle comprising the all-solid-state battery provided herein.

### EXAMPLE EMBODIMENTS

These and other features of the present disclosure may be understood from the following detailed description and will become more fully apparent from the example embodiments of the present disclosure. Also, it will be easily understood that the objects and advantages of the present disclosure may be realized by the means shown in the appended claims and combinations thereof.

### Summary not Limiting

It is understood that this disclosure is not limited to the examples summarized in this Summary. Various other aspects are described and exemplified herein.

### BRIEF DESCRIPTION OF THE DRAWINGS

FIG. 1 illustrate a flowchart of the code scripts in the simulation process according to an embodiment of the present disclosure.

FIG. 2 illustrates a simulation box generated in the pre-processing stage according to an embodiment of the present disclosure.

FIG. 3 illustrates an example size distribution of the solid electrolyte particles.

FIG. 4 illustrates a compressed simulation box generated in the processing stage according to an embodiment of the present disclosure

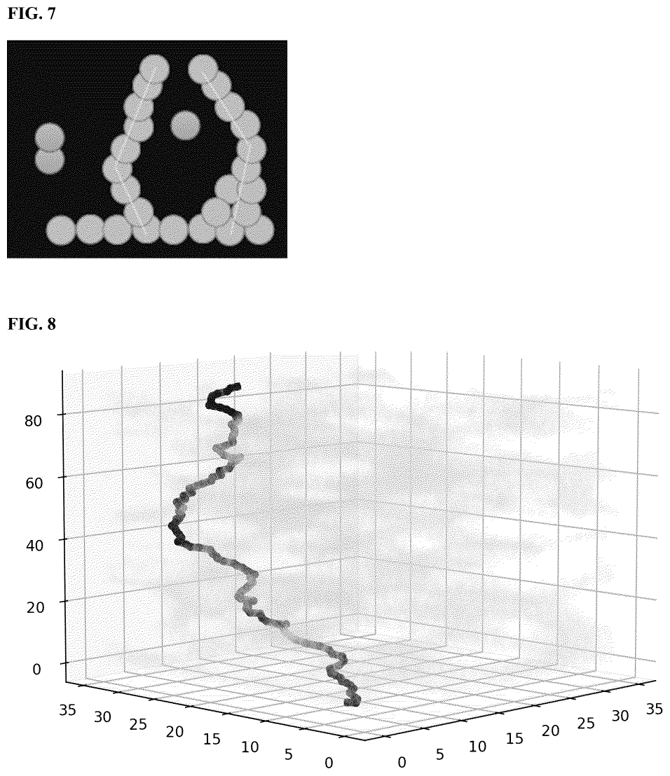

FIG. 5 illustrates connected solid electrolyte (SE) particles.

FIG. 6 illustrates connected SE particles and connected cathode/electrode active material (CAM or EAM) particles.

FIG. 7 illustrates different paths of connected SE particles

FIG. 8 illustrates a SE path in the three-dimensional space.

FIG. 9 illustrates an example pellet cell with different simulations.

FIGS. 10A to 12B illustrate examples of various particle size distributions (FIGS. 10A, 11A, and 12A) and the respective resultant simulation boxes (FIGS. 10B, 11B, and 12B).

FIG. 13 is an example of a solid state battery according to one embodiment.

FIGS. 14A-14C [ADD ACCORDING TO THE EXAMPLES]

### Exemplifications not Limiting

The exemplifications set out herein illustrate certain non-limiting embodiments, in one form, and such exemplifications are not to be construed as limiting the scope of the appended claims in any manner.

### DETAILED DESCRIPTION

### Examples and Embodiments

The presently disclosed subject matter now will be described and discussed in more detail in terms of some specific embodiments and examples with reference to the accompanying drawings, in which some, but not all embodiments of the invention are shown. Like numbers refer to like elements or parts throughout unless otherwise referenced. The presently disclosed subject matter may be embodied in many different forms and should not be construed as limited to the specific embodiments set forth herein. Rather, these embodiments are provided so that this disclosure will satisfy applicable legal requirements. Indeed, many modifications and other embodiments of the presently disclosed subject matter will come to the mind of one skilled in the art to which the presently disclosed subject matter pertains. Therefore, it is to be understood that the presently disclosed subject matter is not to be limited to the specific embodiments disclosed and that modifications and other embodiments are intended to be included within the scope of the appended claims.

### Definitions

### “A,” “An” and “The”

As used herein, the singular form of a word includes the plural, unless the context clearly dictates otherwise. The plural encompasses the singular and vice versa. Thus, the references “a,” “an” and “the” are generally inclusive of the plurals of the respective terms. For example, while the present disclosure has been described in terms of “a” layer, “a” substrate, “a” cell, and the like, more than one of these and other components, including combinations, can be used.

### “About”

The term “about” indicates and encompasses an indicated value and a range above and below that value.

### “Comprise,” “Consisting Essentially Of”, and “Consisting Of”

The words “comprise,” “comprises,” and “comprising” are to be interpreted inclusively rather than exclusively. Likewise, the terms “include,” “including” and “or” should all be construed to be inclusive, unless such a construction is clearly prohibited from the context. A disclosure of an embodiment defined using the term “comprising” is also a disclosure of embodiments “consisting essentially of” and “consisting of” the disclosed components. The phrase “consisting of” excludes any element, step, or ingredient not specified.

### “And/Or”

The term “and/or” used in the context of “X and/or Y” should be interpreted as “X,” “Y,” or “X and Y.”

### “On” and “Over”

As used herein, the terms “on,” “applied on,” “formed on, “deposited on,” “provided on,” and the like mean applied, formed, overlaid, deposited, or provided on in contact with an underlying or overlying surface. On the other hand, the terms “over” “applied over,” “formed over,” “deposited over,” “overlay,” “provided over,” and the like, mean applied, formed, overlaid, deposited, or provided on or over but not necessarily in contact with the surface. For example, a formed layer “applied over” a substrate layer may contact the substrate without an intervening material; however, the same phrase does not preclude the presence of one or more other layers of the same or different composition located between the formed layer and the substrate layer.

### Markush Group

As used herein, the term “combination thereof” included in any Markush-type expression means a combination or mixture of one or more elements selected from the group of elements disclosed in the Markush-type expression, and refers to the presence of one or more elements selected from the group. The term “combinations thereof” includes every possible combination of elements to which the term refers.

### “Between”

As used herein, the expression “between” is inclusive of end points.

### Numerical Ranges

Furthermore, all numerical ranges herein should be understood to include all integers, whole or fractions, within the range. Moreover, any numerical range recited herein is intended to include all sub-ranges subsumed therein, and these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth. When ranges are given, any endpoints of those ranges and/or numbers within those ranges can be combined with the scope of the present disclosure.

### “Including,” “Such As” and “for Example”

As used herein, “including,” “such as,” “for example,” and like terms mean “including/such as/for example but not limited to.”

### Combination of Embodiments

As used herein, the term “example,” particularly when followed by a listing of terms, is merely illustrative, and should not be deemed to be exclusive or comprehensive. Any embodiment disclosed herein can be combined with any other embodiment disclosed herein unless explicitly indicated otherwise.

### Particle Size

As used herein, particle size refers to the mean particle diameter (D₅₀) as measured using microscopy (e.g., optical microscopy, electron microscopy, scanning electron microscopy (SEM), transmission electron microscopy (TEM), atomic force microscopy (AFM), confocal microscopy, X-ray microscopy, cryo-electron microscopy, Raman microscopy, or fluorescence microscopy). The size can be the diameter of spherical particles or the length along the largest dimension of ellipsoidal or otherwise irregularly shaped particles. As used herein, “D50” of particles refers to the diameter at which 50% of the particles have a smaller diameter.

### Simulation Process Overview

### Methods of Designing and Making Batteries by Simulation

The present disclosure provides methods of designing and making all-solid-state batteries by simulating the behavior of an all-solid-state battery pellet cell using discrete element modeling and LAMMPS software.

### Discrete Element Modeling

Discrete Element Modeling (DEM) is a numerical technique used to simulate and analyze the behavior of systems composed of discrete, interacting particles. DEM considers each particle as a separate entity, with its interactions governed by physical laws. Particles can be represented as spheres, ellipsoids, or custom shapes in DEM, but in the methods provided herein, particles are represented as spheres. Each particle has its own physical properties, such as size, density, and stiffness. Particle-particle and particle-boundary interactions are modeled using contact mechanics, which considers forces like normal and tangential forces, friction, cohesion, and damping. Newton's second law of motion is applied to each particle to calculate acceleration, velocity, and position over time. Contact models, such as the Hertz-Mindlin model, define how particles interact mechanically. The simulation progresses incrementally in time (“time stepping”) using explicit time integration methods to solve equations of motion. DEM Captures detailed particle-scale behavior, can model complex particle shapes and interactions, and allows for studying dynamic phenomena like breakage, segregation, and mixing. However, DEM is computationally intensive, requires careful calibration of material and interaction parameters, and is sensitive to time step size and numerical stability issues.

### LAMMPS Software

LAMMPS (Large-scale Atomic/Molecular Massively Parallel Simulator) is an open-source molecular dynamics (MD) simulation software. It is highly versatile, capable of simulating a variety of physical systems, including atomic, molecular, granular, and mesoscale systems. LAMMPS is particularly well-suited for large-scale simulations due to its efficient parallel computation capabilities. LAMMPS models atomic-scale systems (e.g., metals, polymers, biomolecules) and mesoscale or granular systems (e.g., powders, colloids). It is compatible with many types of potentials (e.g., Lennard-Jones, EAM, Tersoff, harmonic, granular interaction models). LAMMPS has specific packages (e.g., the GRANULAR package) for DEM, allowing simulations of particulate systems. It supports frictional, cohesive, and non-cohesive particle-particle contact models. LAMMPS itself does not include visualization tools but outputs data compatible with tools like OVITO, VMD, and Paraview for post-processing.

### Script Files for Simulation Process

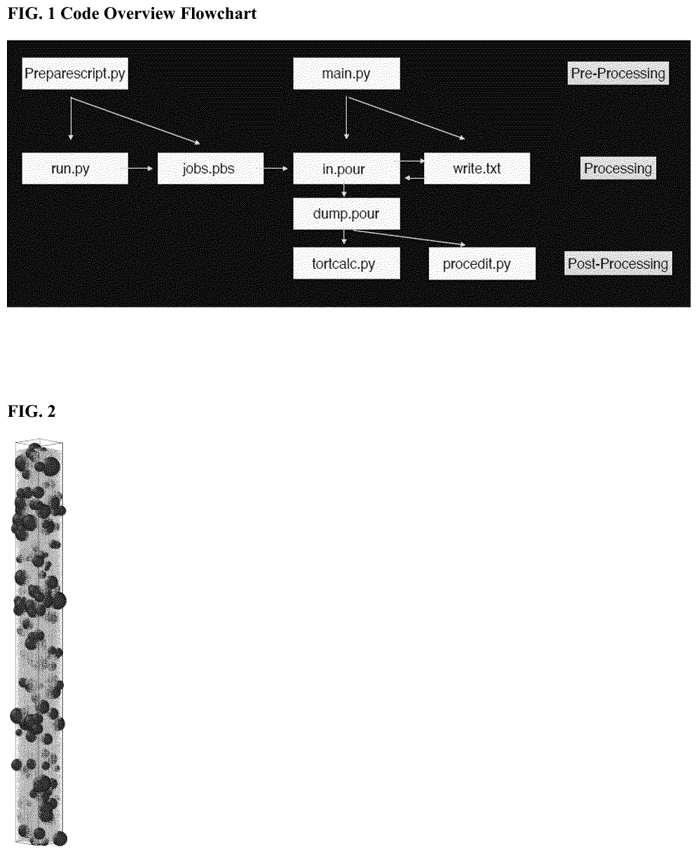

As illustrated in FIG. 1, the simulation process begins with the creation of particle positions, types, and sizes, which can be generated by a Python script called “main.py.” This script stores the generated data in a file labeled “write.txt.” In addition, “main.py” generates a LAMMPS input script, “in.pour,” which defines the type of simulation, specifies the inter-particle forces to be applied, and outlines other simulation parameters. A separate, simpler Python script is used to prepare.pbs job files required for submission to a supercomputer. Another script, “run.py,” automates the submission of multiple jobs, such as approximately 60 jobs, at once, allowing for efficient management of the computational workload. Once the necessary files are transferred to a supercomputer, the “run.py” script is executed from the terminal. This script submits each job file to the supercomputer, instructing it to run the corresponding LAMMPS simulation. The results are stored in a “dump.pour” file, which contains particle data at each time step, including normalized positions ranging from 0 to 1. Following the completion of the simulation, post-processing is conducted on the data. The last time step of the simulation data is extracted from the “dump.pour” file. The normalized particle positions are then converted into actual distances, measured in micrometers, to facilitate subsequent calculations. This conversion enables the determination of whether two particles are in contact by comparing the distance between their centers to the sum of their radii. Two primary post-processing scripts are employed: “Tortcalc.py,” which calculates tortuosity by identifying the shortest or median path between the top and bottom layers of the system, and “Procedit.py,” which computes porosity and calculates the percentage of CAM (positive electrode or cathode active material) or electrode active material (EAM) particles connected to the solid electrolyte network. Hereinafter, CAM is used as an example of the EAM in general. It is understood that the methods provided herein may be used for any electrode active material or electrode material in general.

### Multiple Simulations

To account for stochastic variations in the particle distribution, multiple simulations are performed with different random number seeds, and the results are averaged. This procedure provides more accurate predictions of the behavior of the entire pellet cell. The methodology also allows for the adjustment of particle size distributions, which are important for evaluating performance metrics such as CAM utilization, tortuosity, and porosity. These metrics can further be used to estimate ionic conductivity in the simulated electrode system.

### Target CAM Content

The target CAM content in the electrode can be initially set at a predetermined value, such as 85% by weight. Although this assumption of uniform CAM particle size is not entirely accurate, the variation in particle sizes compensates for this by balancing larger particles with smaller ones. The pre-processing stage involves iterating the model until the pre-processed weight is approximately 85%. During these iterations, adjustments are made to the target weight, and the process continues until the final CAM content remains in the desired range of 84-86% by weight.

### Asymmetrical Size Distributions

However, when using skew-normal distributions for particle sizes, the size distribution is not symmetric. For example, the distribution of sizes of particles at the 75th and 25th percentiles are not symmetric. This introduces additional variability into the system. The packing of particles, which occurs during the processing stage, is not as clean as in symmetric distributions, resulting in greater uncertainty and variability in the final results. Through repeated adjustments and fine-tuning, the system is iterated multiple times to achieve a final weight distribution close to 85% CAM.

### Providing Framework

The results of each simulation iteration are stored and analyzed to track the changes in CAM content before and after processing. These results show the behavior of various combinations of particle size distributions and CAM contents. Despite the challenges of achieving perfect consistency within, for example, the 84-86% range, the methodology ultimately provides a reliable framework for simulating and optimizing the composition of all-solid-state battery electrodes.

### Improved Modeling

Furthermore, the method for modeling the pellet cell well reflects real-world conditions. The electrode size is modeled at a larger scale (100 μm in height), and the size ratio between the positive electrode active material and solid electrolyte is more than twice as large as in previous studies. This improved modeling approach is capable of more accurately simulating the behavior of actual materials used in the development of all-solid-state batteries. The results of these simulations are compared with experimental data to further validate the model and provide insights into how electrode composition can be adjusted to maximize energy density. Batteries can then be designed and manufactured accordingly.

### Pre-Processing Stage

### Pre-Processing Overview

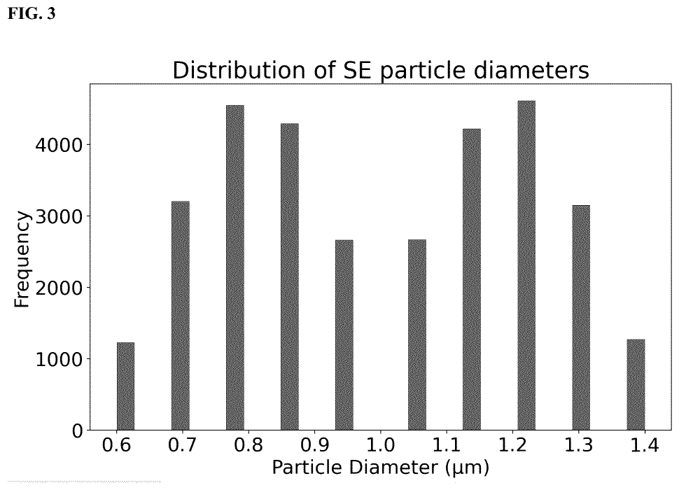

The pre-processing step generates a digital representation of randomly mixed materials used for an electrode as illustrated in FIG. 2. This process determines the number and size of particles for each material, creating a digital simulation of the randomly mixed materials, namely, a simulation box containing the mixed materials, as illustrated in FIG. 2. Additionally, key parameters such as forces and effective properties are calculated and passed to subsequent processing stages.

### Inputs

The inputs for the pre-processing include both material properties and simulation parameters. For all materials, including the solid electrolyte (SE), cathode active material (CAM), conductive material (CM), and binder, the required properties are density and weight percentage. For SE and CAM specifically, the particle size distribution is characterized by parameters, such as D5, D50, or D95, and the distribution type, such as normal, lognormal, skew normal with skew, or bimodal, as well as discretization. Additional mechanical properties for SE and CAM include Young's Modulus, Poisson's Ratio, friction coefficient, and coefficient of restitution, etc. The simulation parameters include the dimensions of the simulation box, the level of discretization, defined as the number of particles along each edge of the simulation box, and the applied pressure.

### Discretization

Discretization of a simulation box refers to dividing the simulation domain into smaller, manageable subdomains (cells or grids) to efficiently perform calculations, such as tracking particles, computing forces, or solving equations. It is widely used in DEM and MD. In particle-based methods, such as DEM or MD, discretization helps identify neighboring particles more efficiently. The simulation box is divided into smaller subdomains (e.g., bins or voxels), and only particles within the same or adjacent subdomains are checked for interactions. Subdomains allow force or property calculations (e.g., density, stress, pressure) to be localized, reducing computational cost. Subdomains can be assigned to different processors in parallel simulations, enabling efficient use of computational resources. The simulation box may be divided into uniform cubic or rectangular cells of equal size. In LAMMPS, the simulation box is divided into uniform cells for efficient particle interaction calculations. Each particle is assigned to a grid cell. Only particles in the same cell or neighboring cells are considered for interactions.

### Pre-Processing Methodology

The pre-processing begins with the calculation of volumes for the CAM and SE based on their respective densities and input weight percentages. Using these calculated volumes, a random number generator initialized with a pre-assigned seed value is employed to determine whether each particle should be assigned as CAM or SE. This assignment is made based on the volume ratio of CAM to SE and the average particle diameter (D50) of each material. The size of each particle is then determined using a second random number generator in conjunction with the cumulative distribution function of the predefined particle size distribution. For skew-normal or other non-symmetric particle size distributions, determining particle size involves a more complex approach. Specifically, an iterative guess-and-check method is employed to solve the inverse problem and ensure that the material distribution aligns with the desired weight percentage of CAM.

### Random Number Generator

A random number generator (RNG) is a tool or algorithm used to produce sequences of numbers that lack any discernible pattern. These numbers can either be truly random (based on physical phenomena) or pseudorandom (computed via deterministic algorithms). RNGs are essential in simulations, statistical sampling, cryptography, machine learning, and various numerical techniques. True Random Number Generators (TRNGs) use physical processes (e.g., radioactive decay, thermal noise) to generate randomness. Pseudorandom Number Generators (PRNGs) use deterministic algorithms to produce sequences of numbers that appear random. A seed value is required to initialize the sequence. Quasirandom Number Generators generate low-discrepancy sequences for specific applications (e.g., Monte Carlo integration). In LAMMPS, RNGs are used to initialize particle positions, velocities, or other stochastic processes. Seed values determine the reproducibility of simulations.

### Output

The output of the pre-processing step is a digitally simulated, randomly mixed configuration of materials. Additionally, the process provides calculated parameters such as forces and effective properties, which are subsequently utilized in further simulation or processing stages.

### Discretized Grid

The simulation box, as illustrated in FIG. 2, may contain tens of thousands of particles arranged in a pre-sized, discretized grid. This grid facilitates the correct distribution of particles and introduces randomness to their initial positions, mimicking the random mixing of materials in real-life scenarios. The process utilizes the RNG in a simplified Monte Carlo approach. Each grid space is sequentially processed to determine the particle type (e.g., CAM or SE) using the RNG. A secondary random number generator assigns the particle size based on the predefined particle size distribution.

### Monte Carlo Approach

The Monte Carlo approach is a computational method that relies on repeated random sampling to solve problems that might be deterministic in principle. It is particularly useful for problems involving uncertainty, complex integrations, or systems with many degrees of freedom. It uses random numbers or stochastic processes to explore possible outcomes. The output is analyzed statistically to estimate results. A simplified Monte Carlo approach distills the method down to its core: random sampling and averaging. First, the problem-what is to be estimated—is defined. Then, a RNG is used to produce inputs in the required range or domain. The function value is computed for each random input. Finally, the average of the computed values is used to estimate the result.

### Example

For example, if 85% CAM by weight is desired, the mixture's densities and compositions, including CAM, SE, CM, and binder, are analyzed to derive an approximate CAM volume of 70%. An intermediate value is calculated to relate the percentage of CAM by volume to the mean CAM particle size distribution and the mean SE particle size distribution. For example, the intermediate value may be “probability_CAM,” which equals to (CAM_vol/CAM_pvol)/(CAM_vol/CAM_pvol+SE_vol/SE_pvol). For an electrode active material (EAM) in general, the intermediate value “probability_EAM” equals to (EAM_vol/EAM_pvol)/(EAM_vol/EAM_pvol +SE_vol/SE_pvol). The volume of CAM (denoted as CAM_vol) or EAM (denoted as EAM_vol) represents the proportion of CAM or EAM volume compared to the total solid volume, excluding porosity. This is derived directly from the desired CAM or EAM weight percentage and the known densities of the materials in the mixture. CAM_pvol or EAM_pvol is a mean volume of the spherical CAM or EAM particles, and SE_pvol is a mean volume of the spherical SE particles. The probability value representing a number of the spherical SE particles for each spherical CAM or EAM particle.

### Calculation of Volume

The calculation of CAM_vol begins by dividing the desired CAM weight by its density: CAM_vol=(CAM_wt %/CAM_density)/(CAM_wt %/CAM_density+SE_wt %/SE_density). For EAM in general, EAM_vol=(EAM_wt %/EAM_density)/(EAM_wt %/EAM_density+SE_wt %/SE_density). This provides the CAM or EAM volume, which is then normalized against the total solid volume (CAM_vol+SE_vol) or (EAM_vol+SE_vol). The expected CAM or EAM particle volume (CAM_pvol) or (EAM_pvol) is based on the mathematical expectation of the CAM or EAM particle size distribution. For example, for symmetric distributions, such as normal distributions, this is equivalent the volume of a single particle, calculated using the formula 4/3πr³, where r is the mean particle radius (D50).

### Assigning Particles

Given the size discrepancy between CAM and SE particles, the probability of assigning a particle as CAM is approximately 3.17% to achieve 70% CAM by volume. This translates to roughly 30 SE particles for every CAM particle. The grid is iteratively filled by processing every point within the discretized space, beginning at (0,0,0) and continuing systematically through (0,0,1), (0,1,0), (1,0,0), and so forth, until the entire simulation box is populated.

### Defining Particle Size Distribution

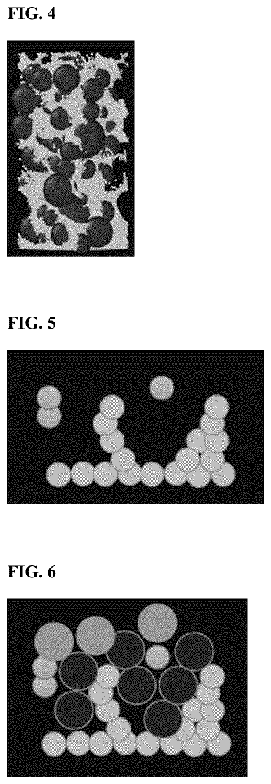

A second iteration of this process refines the particle size distribution. Instead of a single boundary for particle type, multiple boundaries are introduced to account for discrete particle size bins. For example, as illustrated in FIG. 3, with 10 discrete particle sizes for both CAM and SE, nine boundaries are established for each type, and the particle size distribution dictates the cut-off points for these boundaries. At the end of this process, tens or hundreds of thousands of particles populate the simulation box, each assigned a specific size and type. The total volumes of CAM and SE within the simulation box is determined. If the resultant CAM volume percentage deviates from the expected 70%±1%, the entire process is repeated. Due to the inherent randomness in the number generation, multiple iterations eventually converge to the desired particle distribution.

### Determining Cutoffs or Boundaries

The simulation setup involves determining the cutoffs or boundaries for discrete size distributions. In a standard scenario such as rolling a die, probabilities are evenly distributed across all outcomes, but in this case, a Gaussian (bell curve) distribution is used, requiring adjustments to the placement of these boundaries to accurately represent the problem. The continuous distribution is discretized into bins, with the number of bins optimized to balance performance and accuracy. For instance, ten bins were found to yield the best performance, providing a good balance between computational time and accuracy. Higher numbers of bins did not significantly improve the results and would increase computational time due to the higher number of inter-particle combinations.

### Simulation Boundaries

The simulation boundaries for the x and y directions are set to a size chosen to reduce computation time, for example, 35 micrometers. Initially, a larger boundary, such as 150 micrometers, was used, but the results were similar, and the smaller boundary size significantly reduced computation time, as reducing the size by a factor of approximately 4.3 (150\hat{ }2/35\hat{ }2) led to a reduction in processing time by about 18 times. These boundaries are periodic, meaning that if a particle crosses the boundary in the x-direction, it reappears on the opposite side, effectively reducing computational complexity and conserving matter and momentum. The height of the simulation boundary is more variable, determined through iterative testing to ensure that the total weight of the particles matches the desired target value, such as 100 mg. The height is adjusted based on trial and error until the weight is within an acceptable range, with minor variations observed due to the stochastic nature of particle packing.

### Generating Output Files

Once the CAM and SE distributions are validated, two output files are generated. The first file contains the Cartesian coordinates (x, y, z), particle types, densities, and radii of all particles, formatted for input into the LAMMPS software. The second file is a LAMMPS script that defines the simulation boundaries, specifies the pairwise particle interactions, and provides instructions to apply forces across the particles over a designated number of time steps.

### Calculating Forces

The total force applied to the system is calculated by multiplying the simulation box's cross-sectional area by the stress applied. The force per particle is distributed based on the volume ratio of CAM to SE. Forces are further apportioned among all particles of each type, ensuring accurate representation of particle interactions. These calculated forces and particle properties are included in the LAMMPS input file, which serves as the basis for the subsequent processing stage.

### Repeating Simulation

The simulation process is repeated hundreds of times with varying input parameters, such as the desired CAM percentage and particle size distributions. For each test, two files are generated: the particle data file and the corresponding LAMMPS script. An additional Python script prepares job files, specifying details such as the servers to use, resource allocation, and execution time for each simulation.

### Processing Stage

### Molecular Dynamics Simulation

The processing stage involves simulating the fabrication pressure on the material using LAMMPS, a software used for molecular dynamics simulations. The granular package of LAMMPS is specifically utilized for simulating the interactions between particles. The Hertz/material pair_style in LAMMPS is used to model the inter-particle forces based on Hertzian (non-linear) mechanics, where the normal (Kn) and tangential (Kt) stiffness constants are determined based on the material's Young's modulus. The simulation is run with periodic boundary conditions and uses a time step size of 5e-05, continuing until the system reaches equilibrium, meaning all particles settle and the velocity of each particle becomes negligible. Typically, this requires approximately 250,000 time steps. Neighbor pages are pre-allocated to optimize the simulation by reducing computation time after the initial stages, although this can lead to a slower early portion of the simulation. In LAMMPS, neighbor pages refer to the sections of the code that deal with identifying neighboring particles for a given particle within a simulation.

### Executing Simulation

The files required for the simulation are transferred from the local machine to the supercomputer using the SCP command in the terminal. After transferring the necessary files, the simulation is executed on the supercomputer using scripts created during the pre-processing stage. These scripts direct the supercomputer to run the specific tests in LAMMPS, facilitating the analysis of different configurations and behaviors.

### Pressing Simulation Box

As illustrated in FIG. 3, the simulation in the processing stage generates a digital representation of a compressed simulation box under a pressure along a vertical axis between the top and the bottom of the simulation box. As a result, the simulation box expands in the other two dimensions. The simulation box is compressed until each of the CAM (or EAM) and SE particles touches at least one neighboring particle and the particles in the simulation box reach an equilibrium state. The applied pressure in the simulation mimics the pressure used to fabricate a pellet cell in real life, such as at or about 375 MPa. This step may also involve some post-processing. For example, the post-processing may determine a height of the specimen that results in the same weight as the actual experiment, and the processing may generate a compressed simulation box that has the same height.

### Modeling Mass

The processing stage may also involve accurately modeling the mass of a pellet cell cross-section. The process begins by determining the actual weight of an experimentally derived pellet cell, which has a known radius and mass. For example, a pellet cell with a radius of 500 micrometers may have a mass of 22.7 mg. Based on this experimental data, the corresponding mass for a computational cross-section of the simulation box is calculated. For instance, a 35×35 micrometer cross-section may correspond to approximately 0.035 mg. Once the target mass for the cross-section is established, the simulation box is populated with simulated particles as described herein. This process continues until the total simulated mass slightly exceeds the desired target, such as reaching 0.036 mg. After the simulation box is pressed, the total mass of the particles within the simulation box is accounted for until it reaches the target mass, and the remaining particles, such as those on the very top of the simulation box that are not included in the target mass, are removed from the simulation. The unmodeled mass components, such as carbon and binder, are also accounted for to maintain consistency with the real-world pellet cell composition.

### Particle Interactions

LAMMPS uses simplified models, such as Hooke's Law, to describe particle interactions. In LAMMPS, the primary force between particles is modeled as a spring-like interaction, with the force being proportional to the displacement. The Hertzian contact model used in the present disclosure accounts for some non-linearity, unlike Hooke's Law, making it a better fit for particle interactions. The force applied to each particle in the simulation is determined by the pressure being applied across the entire specimen. For example, if a pressure of 100 MPa is applied to a specimen of 35 micrometers by 35 micrometers, the corresponding force is calculated by multiplying the pressure by the area. This force is then distributed among the particles in the system, with the volume fraction of the active material determining the amount of force allocated to each type of particle (e.g., CAM, EAM, or SE particles).

### Simulation Optimization

To optimize the simulation, careful consideration must be given to selecting an appropriate number of particles and determining the corresponding simulation size. Choosing too few particles can lead to significant inaccuracies, as it may not adequately represent the physical system under study. In such cases, the interactions among particles may be insufficient, resulting in a failure to capture essential phenomena, such as collective behaviors or phase transitions. Conversely, overestimating the number of particles introduces another set of challenges. When too many particles are included, the forces applied to each individual particle become diluted. This underestimation of the force can significantly affect the accuracy of the simulation, leading to misleading results regarding the dynamics of the system.

### Velocity Verlet Algorithm

The time integration method employed in LAMMPS for updating particle positions and velocities is the Velocity Verlet algorithm. The Velocity Verlet algorithm is a numerical method for integrating the equations of motion in molecular dynamics simulations. This algorithm is particularly well-regarded for its accuracy and efficiency in calculating both position and velocity at each time step. It is particularly favored for its stability and ease of implementation, making it suitable for systems with many interacting particles. It computes new positions based on current positions and velocities and then updates velocities based on the forces acting on the particles. The Velocity Verlet algorithm minimizes the risk of introducing numerical instabilities that can arise from less sophisticated integration methods. The algorithm is time-reversible, which is a desirable property for physical simulations.

### Equilibrium State

As the particles interact with one another, their movement is governed by a variety of forces, including inter-particle forces, external applied pressure, and possibly thermal fluctuations. These forces dictate how particles collide, rebound, and rearrange, ultimately influencing the evolution of the system. The system gradually evolves toward an equilibrium state, characterized by a stable configuration of particles where the net forces acting on them are balanced. Throughout the simulation, as particles interact and rearrange themselves under the influence of the forces, the potential energy of the system is monitored. The simulation continues until the system's potential energy reaches a nearly constant value, indicating that the particles have settled into their equilibrium configuration. This equilibrium state signifies that the particles have reached a minimum energy configuration, with their motion becoming increasingly regular and predictable. Such a stable state is crucial for obtaining meaningful insights into the properties and behaviors of the material being studied, whether it be granular materials, molecular systems, or other complex assemblies.

### Preprocessing Steps

The processing stage also involves preprocessing steps that include running various Python scripts to generate the necessary files, moving files between the local machine and the supercomputer, and executing the simulation through the terminal. These preprocessing steps are crucial for setting up the simulation environment and ensuring that the computational resources are efficiently utilized.

### Post-Processing Stage

### Post-Processing for CAM Utilization and Tortuosity

Post-processing enables the calculation of critical parameters like CAM utilization and tortuosity. Once the LAMMPS processing stage is complete, the first step is to extract essential particle information, including the particle type, which identifies whether the particle is CAM or SE based on its density, as well as the size and position of each particle. Following this, an adjacency matrix is constructed. For particles, the matrix dimensions are where each element indicates whether two particles connect or overlap. A value of 1 is assigned if the sum of two particles' radii exceeds their Euclidean distance, indicating connectedness or overlap, and 0 if no connectedness or overlap occurs. Alternatively, an overlap criterion may be used. For example, two particles are connected or overlapping and thus a value of 1 is assigned if the sum of their radii is greater than 102% of the Euclidean distance between the two particles.

### Python Files

Python is used to read the LAMMPS dump files, extracting the particle information from the final time step. Two types of files are prepared during this stage. Normalized files, where the simulation and particle positions are scaled between 0 and 1, are used for visualization purposes in software such as OVITO. Non-normalized files, with dimensions retained in microns, are reserved for calculation purposes.

### Calculation of CAM Utilization

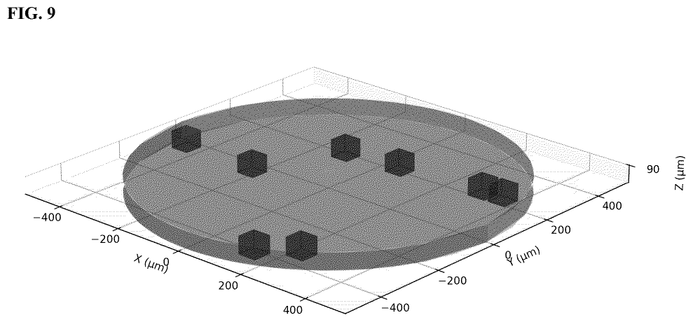

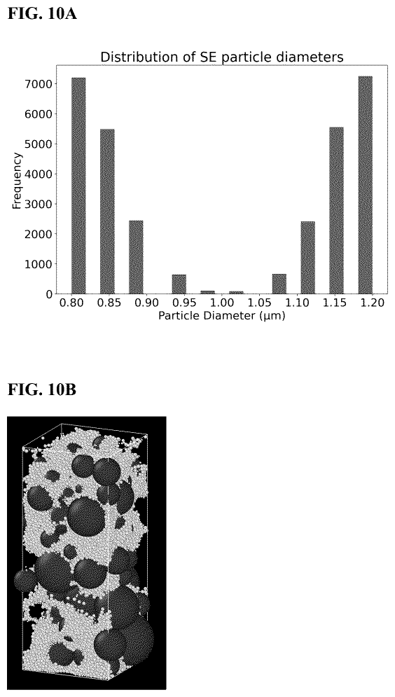

The calculation of CAM utilization involves identifying the SE particles that are connected to the simulation floor, where z=0, or the z-position of the particle is less than its radius. From this starting point, the adjacency matrix is used to propagate connectivity to identify the connected SE mass by checking which SE particles are touching those particles connected to the simulation floor, using a lookup from the premade adjacency matrix, and iterating through every SE particle until the number of the connected SE particles does not increase anymore. As illustrated in FIG. 5, the yellow particles are connected SE particles with the row of particles on the bottom touching the simulation floor; and the green particles are not connected. Once the connected SE mass is determined, the CAM particles that are in contact with this mass are identified. As illustrated in FIG. 6, the purple CAM particles are connected to the connected SE particles, and the red ones are not. The volume of the connected CAM particles is calculated and compared to the total volume of all CAM particles. This ratio represents the percentage of CAM particles that are “active” and defines the CAM utilization.

### Tortuosity Estimation

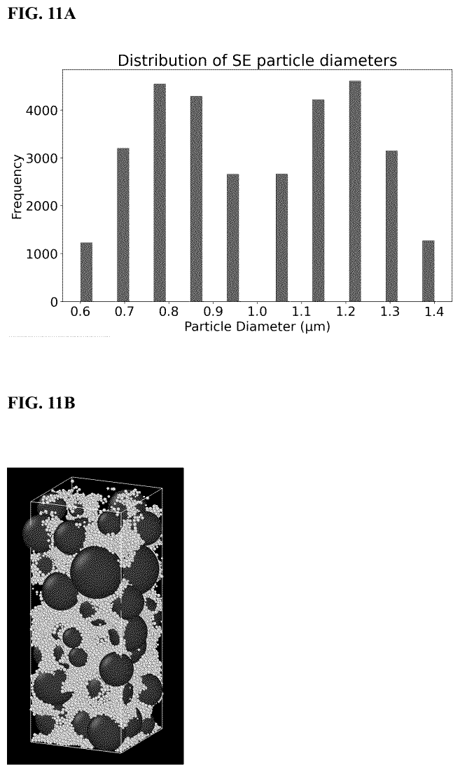

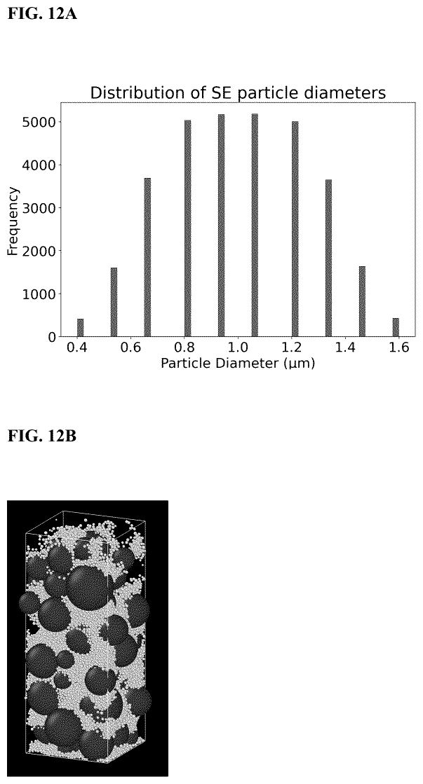

Tortuosity estimation begins with analyzing connectivity. Tools are created to measure connectivity using an adjacency matrix to identify particles that are touching and a k-dimensional tree from SciPy for efficient spatial queries. SE particles near the top and bottom of the simulation box are identified using a predefined cutoff, such as 1 micron, which can be changed. Paths are traced through the centers of connected SE particles. Only paths through connected or overlapping particles, where the sum of their radii is equal to or greater than the distance between particles or an overlap criterion, such as 102% of the distance, are considered. As illustrated in FIG. 7, the yellow particles from the top to the bottom are identified as the connected SE particles, and the paths through the centers of these particles from the top to the bottom are shown as the green lines. This may be done for all the paths or alternatively, selected, such as one thousand, random paths among all possible paths in the three-dimensional space from the top to the bottom of the simulation box, as illustrated in FIG. 8, to identify a target path, which is the shortest path or the median of the selected paths through the connected SE particles. The relative tortuosity is calculated by dividing the shortest or median path length by the Euclidean distance between the start and end points.

### Calculating Porosity

To calculate porosity, the simulation height is adjusted iteratively to match the experimental material mass. For instance, if the experiment uses 22.7 mg of material, the simulation is adjusted until it closely approximates this value. The total volume of the system is determined by multiplying the simulation height by the cross-sectional area. The volume of solids is calculated as the sum of the volumes of all particles. Porosity is then obtained by subtracting the volume of solids from the total volume, yielding the volume of voids, which is divided by the total volume to calculate the porosity as a fraction.

### Combining Post-Processing Steps

By combining these post-processing steps, parameters like CAM utilization and tortuosity are accurately quantified, contributing to a deeper understanding of the pellet cell's behavior.

### Simulation Code Scripts

### Pre-Processing and Processing Scripts

As illustrated in FIG. 1, all the processes in the pre-processing stage are handled in the main.py script. This script generates the positions, types, and sizes of all particles, which are stored in a file called ‘write.txt’. It also creates the LAMMPS script, “in.pour,” which defines the simulation type, inter-particle forces, and other parameters. A separate, simpler Python script prepares the necessary.pbs files, which are job files required to submit the LAMMPS simulation to the supercomputer. Additionally, a script called run.py automates the submission of multiple jobs simultaneously. Once all files are transferred to the supercomputer, the run.py script is run from the terminal. This submits each jobs.pbs file, instructing the supercomputer to run each LAMMPS simulation defined in the “in.pour” file. After the simulations are completed, which takes anywhere from 8 hours to 2 days, the system generates a dump file, “dump.pour”, containing the particle data at each time step, including normalized positions (ranging from 0 to 1).

### Post-Processing Scripts

In the post-processing stage, the data from the last time step in the “dump.pour” file is read. The coordinates, which are initially normalized, are then converted into micrometers for easier calculation. This transformation allows determining whether two particles are touching by checking if the distance between them is smaller than the sum of their radii. There are two main post-processing scripts. One is “Tortcalc.py.” This script calculates the paths of connected solid electrolyte (SE) particles and identifies the shortest or median path between the top and bottom layers. The path length is then divided by the Euclidean distance between these two points to determine tortuosity. The other script is “Procedit.py.” This script calculates porosity and identifies SE particles connected to the bottom layer, as well as all particles connected to them. The percentage of CAM (positive electrode active material) particles connected to this SE mass is then calculated, which gives us CAM utilization.

### Multiple Simulations

### Repeating and Averaging

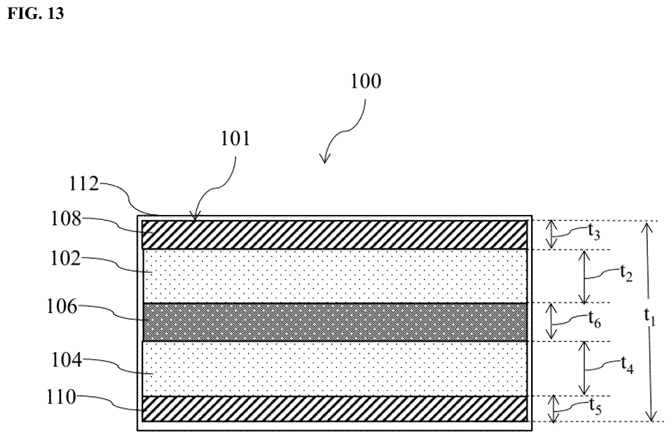

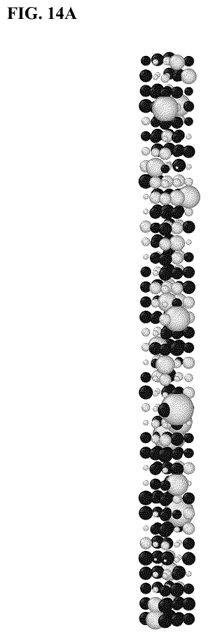

This method is repeated across multiple simulations to account for the randomness in the mixing process. By averaging the results from these simulations, a more reliable estimate of the pellet cell's behavior can be obtained. As shown in FIG. 9, the green area represents the pellet cell, while the blue boxes show the different simulations. Multiple simulations are performed for each input by altering the random number generation seed value. This method also allows for variations in particle size distributions to calculate key metrics such as CAM utilization, tortuosity, and porosity, which can be used to estimate ionic conductivity. FIGS. 10A to 12B illustrate examples of various particle size distributions and the respective resultant simulation boxes.

### Target CAM Content

Regarding the target CAM content, initially, a pre-selected content, for example, 85% by weight, is aimed for, assuming a uniform CAM particle size. Although this assumption is not perfect, the distribution of particle sizes compensates for this, with larger particles balanced by smaller ones. After processing, the CAM content remains close to the pre-selected value. For example, when 85% is the target, the CAM content may be in the range of 84-86% by weight.

### Skew-Normal Distribution

In the case of skew-normal distributions, the particle size distribution is asymmetric. For example, the particle size distribution at the 75th percentile does not correspond symmetrically with the 25th percentile. This results in more uncertainty during the packing process, which can impact the final particle distribution. Therefore, multiple iterations were necessary, with adjustments made to the initial estimates to achieve a pre-processed weight close to 85%.

### Iterations

The iterations may follow this pattern:
C5.3 target weight: 85.4%→final weight: ˜79-81%
C7.5 target weight: 85.3%→final weight: ˜76-78%
C10 target weight: 85.3%→final weight: ˜74-76%

Through repeated adjustments, more accurate starting estimates may be found for the pre-processing stage. These can be further fine-tuned to get values closer to 85% CAM by weight after processing.

### Combinations Hard to Stabilize

Some combinations were harder to stabilize within the 84-86% range, and the results of each combination are recorded for reference. After several rounds of adjustments, the values may converge to the following:
C3 S0.3:86.4%→84.9%
C5.3 S0.79:85.9%→85.7%
C7.5 S0.3:88.0%→82.7%
C10 S1.3:88.5%→85.4%

Eventually, the results may show that it was difficult to exactly fall into the 84-86% range. The combination results can be saved, and the original target weights may be kept from the pre-processed CAM data, noting that these could vary from 91% to 95.75% for different combinations, exceeding the 85% target for symmetric distributions.

### Trial-and-Error

This process is largely trial-and-error, where an initial estimate is provided, the pre-processed weight can be quickly obtained, then the simulation process is conducted to generate the final value. Each variation produces a different outcome, and due to the non-normal distributions, the packing behavior is not perfectly predictable in advance.

### Applying Simulation Results

### Selection of Electrode Composition

After simulations of the positive electrode with the active material, solid electrolyte, and conductive material using the DEM in LAMMPS, the tortuosity, porosity, and CAM utilization are calculated for various compositions and particle sizes. This helps guide the selection of electrode composition that maximizes energy density.

### Comparison

The modeling approach differs from previous studies in several ways. The electrode size is modeled at a larger scale, with a height of 100 μm, and the size ratio of the positive electrode active material and solid electrolyte is more than twice as large as in previous studies.

Validation with Experimental Data

The results of these simulations are also compared with experimental data from pellet cell tests to validate the results.

### Solid State Battery, Making Thereof, and Use Thereof

### Making Battery

After the simulation, an electrode composition can be selected according to the simulation results, and an all-solid-state lithium battery can thus be made accordingly. The battery comprises a first electrode, a second electrode, and an SE layer. The all-solid-state lithium battery can be prepared by preparing the first electrode using the desired set of input parameters; providing the second electrode; providing the carbon material and the binder using the desired set of input parameters; and preparing the SE layer using the desired set of input parameters. More details are provided hereinafter.

### Battery

Another aspect of the present disclosure provides a solid state battery designed and made by the methods provided herein. More details are provided hereinafter.

### Use of Battery

Yet another aspect of the present disclosure provides use of the solid state battery provided herein. A non-limiting example is an electric vehicle comprising the all-solid-state battery provided herein.

### Additional Features

The following provides other aspects of the present disclosure. The additional features, embodiments and examples discussed below will be applicable to various aspects of the invention discussed above. In case there is a conflict between information in the foregoing discussions and information in the following discussions, however, the information in the foregoing section should apply.

### Solid State Lithium Ion Batteries

A solid state battery can receive a charge and discharge an electrical load various times. A solid state battery includes electrodes, a cathode electrode and an anode electrode, and an electrolyte to allow lithium ions to travel between the electrodes. In contrast to conventional liquid electrolyte batteries, the solid state battery does not include any flowable liquids. Forming a circuit between the electrodes causes electricity to flow between the electrodes. During charging of the lithium ion rechargeable battery, lithium ions are emitted from the cathode electrode and are intercalated into an active material of the anode electrode. During discharging of the lithium ion rechargeable battery, lithium ions are emitted from the anode electrode and are intercalated into an active material of the cathode electrode. As lithium ions reciprocate between the electrodes, they transfer energy.

### Solid State Battery Configuration

The present disclosure provides a solid state battery 100 comprising a cathode electrode 102, an anode electrode 104, and a solid electrolyte layer 106 intermediate the cathode electrode 102 and the anode electrode 104. While listed as exemplary, the solid state battery 100 does not require all of these components. For example, in some configurations, such as in anodeless system, the anode electrode 104 may be omitted.

### Optional Additional Layers

The solid state battery 100 can optionally comprise an additional layer or layers, such as, for example, a separator layer, a protective layer, an inhibitor layer, a solid electrolyte interface layer, or a combination thereof.

### Protective Layer

For example, a protective layer may be incorporated between the electrodes 102 and 104 and the solid electrolyte layer 106. The protective layer may also serve to mitigate dendrite formation, particularly on the anode side, thereby improving the overall cycle life and safety of the battery. In some cases, the protective layer may help improve interfacial stability between the electrodes and electrolyte, potentially reducing unwanted side reactions. Additionally, the protective layer may enhance the mechanical properties of the electrode-electrolyte interface, which could be beneficial for maintaining good contact during cycling.

### Protective Layer Materials

This protective layer may comprise materials such as lithium phosphate, lithium titanate, or lithium lanthanum zirconium oxide (LLZO), which can help prevent undesirable side reactions at the electrode-electrolyte interface. Other options for the protective layer material may include, but are not limited to, lithium niobium oxide (LiNbO3), lithium tantalum oxide (LiTaO3), lithium aluminum titanium phosphate (LATP), lithium aluminum germanium phosphate (LAGP), lithium silicate, and lithium boron oxide

### Separator Layer

A separator layer may also be included in some configurations of the solid state battery 100. These separator layers can provide additional mechanical support to the battery structure while still allowing for efficient ion transport. The separator layer may also be designed to have a gradient structure, with properties optimized for contact with both the cathode and anode materials. This gradient structure could involve, for example, varying the porosity, composition, or surface properties across the thickness of the separator. In some aspects, the separator surface may be functionalized with ion-conductive groups or coatings to enhance lithium ion transport at the electrode-separator interfaces. The separate layer may further be designed with multiple layers, by incorporating different materials optimized for specific functions, such as a mechanically strong core layer sandwiched between ion-conductive outer layers. The separator layer may additional be designed to be self-healing e.g., by reforming bonds after mechanical stress to help prevent short circuits caused by dendrite growth.

### Separator Layer Materials

While traditional liquid electrolyte batteries often use porous polymer separators, solid state batteries may employ thin ceramic or glass-ceramic layers as separators. Materials such as LLZO, LATP (lithium aluminum titanium phosphate), or LAGP (lithium aluminum germanium phosphate) may be used for this purpose. Other separator layer materials that may be suitable for solid state batteries include lithium phosphate oxynitride (LiPON), lithium lanthanum titanate (LLTO), lithium garnet-type materials like Li6BaLa₂Ta₂O₁₂, sulfide-based materials like Li10GeP2S12, and polymer-ceramic composites combining materials like polyethylene oxide (PEO) with ceramic fillers.

### Solid State Battery Cell

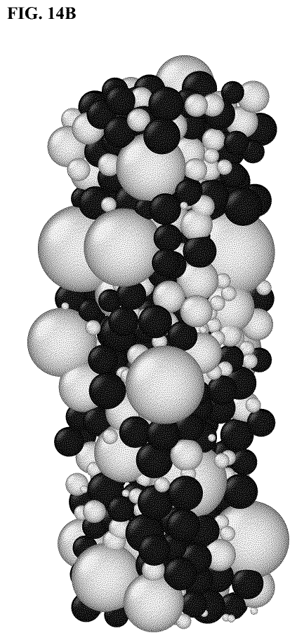

FIG. 13 illustrates a cell 101 of a solid state battery 100 according to an embodiment. The cell 101 includes a cathode electrode 102, an anode electrode 104, and a solid electrolyte layer 106 intermediate the cathode electrode 102 and the anode electrode 104. The cell 101 can optionally include an additional layer or layers, such as, for example, a separator layer, a protective layer, an inhibitor layer, a solid electrolyte interface layer, or a combination thereof.

### Cell Configuration

As illustrated in FIG. 13, the solid state battery 100 may include a single cell 101. In other examples, the solid state battery 100 can include multiple cells, such as, at least two cells, at least three cells, or at least four cells. Connecting the cells in series increases a voltage of the solid state battery 100 and connecting the cells in parallel increases an amp-hour capacity of the solid state battery 100.

### Dimensions of Cell

The cell 101 may have a width, w₁, a length, l₁, and a thickness, t₁.

### Thickness of Cell

A thickness, t₁, of the cell 101 can be at or about any number in a range of from about 100 μm to about 5000 μm, such as about 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400,410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, 1000, 1100, 1200, 1300, 1400, 1500, 1600, 1700, 1800, 1900, 2000, 3000, 4000, or 5000 μm. In some embodiments, the thickness, t₁, of the cell 101 may be within a range formed by selecting any two numbers listed above or by selecting any two numbers within the range of from about 100 μm to about 5000 μm, e.g., between about 100 μm and about 5,000 μm or about 100 μm and about 1,000 μm.

### Aspect Ratio of Width

The width, w₁, of the cell 101 may be substantially greater than the thickness, t₁, of the cell 101. In some embodiments, an aspect ratio of the width, w₁, to the thickness, t₁, may be at least 10, at least 20, at least 30, at least 40, at least 50, at least 60, at least 70, at least 80, at least 90, at least 100, at least 110, at least 120, at least 130, at least 140, at least 150, at least 160, at least 170, at least 180, at least 190, at least 200, at least 210, at least 220, at least 230, at least 240, at least 250, at least 260, at least 270, at least 280, at least 290, at least 300, at least 350, at least 400, at least 450, at least 500, at least 550, at least 600, at least 650, at least 700, at least 750, at least 800, at least 850, at least 900, at least 950, at least 1000, at least 2000, at least 3000, at least 4000, at least 5000, at least 6000, at least 7000, at least 8000, at least 9000, or at least 10000.

### Aspect Ratio of Length

The length, l₁, of the cell 101 may be substantially greater than the thickness, t₁, of the cell 101. In some embodiments, an aspect ratio of the the length, l₁, to the thickness, t₁, may be at least 10, at least 20, at least 30, at least 40, at least 50, at least 60, at least 70, at least 80, at least 90, at least 100, at least 110, at least 120, at least 130, at least 140, at least 150, at least 160, at least 170, at least 180, at least 190, at least 200, at least 210, at least 220, at least 230, at least 240, at least 250, at least 260, at least 270, at least 280, at least 290, at least 300, at least 350, at least 400, at least 450, at least 500, at least 550, at least 600, at least 650, at least 700, at least 750, at least 800, at least 850, at least 900, at least 950, at least 1000, at least 2000, at least 3000, at least 4000, at least 5000, at least 6000, at least 7000, at least 8000, at least 9000, or at least 10000.

### Cathode Electrode

The cathode electrode 102 is associated with one polarity (e.g., positive) of the solid state battery 100. The cathode electrode 102 is configured as a positive electrode during discharge of the solid state battery 100. The cathode electrode 102 is suitable for lithium ion diffusion between a current collector 108 and the solid electrolyte layer 106. The cathode electrode 102 is in electrical communication with the current collector 108.

### Cathode Electrode Positioning

In embodiments, the cathode electrode 102 is formed over and in direct contact with the current collector 108. In other embodiments, another functional layer may be interposed between the cathode electrode 102 and the current collector 108.

### Materials for Cathode Electrode

The cathode electrode 102 may be capable of reversible intercalation and deintercalation of lithium ions. For example, the cathode electrode 102 can comprise a cathode active material alone. In other examples, the cathode electrode 102 may optionally include one or more of a conductive carbon, a solid electrolyte material, and a binder. Optionally, the cathode electrode 102 may further comprise an additive, such as, for example, an oxidation stabilizing agent, a reduction stabilizing agent, a flame retardant, a heat stabilizer, an antifogging agent, a thickener, a plasticizer, an ion conductivity enhancer, a binder (described in detail further below), a dispersant, a wetting agent, an adhesion promoter, a crosslinking agent, a colorant, the like, or a combination thereof.

### Examples of Additives

Examples of these additives may include butylated hydroxyanisole (BHA) or butylated hydroxytoluene (BHT) as oxidation stabilizing agents, ascorbic acid or sodium sulfite as reduction stabilizing agents, aluminum hydroxide or magnesium hydroxide as flame retardants, phenolic compounds or phosphites as heat stabilizers, polyethylene glycol or silica nanoparticles as antifogging agents, and carboxymethyl cellulose (CMC) or xanthan gum as thickeners, dibutyl phthalate or triethyl citrate as plasticizers, ceramic fillers or ionic liquids as ion conductivity enhancers, polyvinylpyrrolidone or sodium dodecyl sulfate as dispersants, polysorbates or poloxamers as wetting agents, silanes or titanates as adhesion promoters, peroxides or aziridines as crosslinking agents, and carbon black or metal oxides as colorants.

### Cathode Active Material

The cathode active material can include lithium cobalt oxide (LiCoO₂), lithium nickel oxide (LiNiO₂), Li[NiₐCo_{b}Mn_{c}M¹_{d}]O₂ (wherein M¹ is any one element elected from the group consisting of Al, Ga, In, or a combination thereof, 0.3≤a<1.0, 0≤b≤0.5, 0≤c≤0.5, 0≤d≤0.1, and a+b+c+d=1), Li(LiₑM²_{f-e-f}M³_{f′})O_{2-g}A_{g} (wherein 0≤e≤0.2, 0.6≤f≤1, 0≤f≤0.2, 0≤g≤0.2, M² includes Mn and at least one element selected from the group consisting of Ni, Co, Fe, Cr, V, Cu, Zn and Ti, M³ is at least one element selected from the group consisting of Al, Mg and B, and A is at least one element selected from the group consisting of P, F, S and N), or those compounds substituted with one or more transition metals; lithium manganese oxides such as those represented by the chemical formula of Li^{1+h}Mn₂₋ₕO₄ (wherein 0≤h≤0.33), LiMnO₃, LiMn₂O₃, LiMnO₂, or the like; lithium copper oxide (Li₂CuO₂); vanadium oxides such as LiV₃O₈, V₂O₅ or Cu₂V₂O₇; Ni-site type lithium nickel oxides represented by the chemical formula of LiNi₁₋ᵢM⁴ᵢO₂ (wherein M⁴=Co, Mn, Al, Cu, Fe, Mg, B or Ga, and 0.01≤y≤0.3); lithium manganese composite oxides represented by the chemical formula of LiMn₂₋ⱼM⁵ⱼO₂ (wherein M⁵=Co, Ni, Fe, Cr, Zn, or Ta, and 0.01≤y≤0.1) or Li₂Mn₃M⁶O₈ (wherein M⁶=Fe, Co, Ni, Cu, or Zn); LiMn₂O₄ in which Li is partially substituted with an alkaline earth metal ion; disulfide compounds; LiFe₃O₄, Fe₂ (MoO₄)₃; the like; or combinations thereof.

### Phosphate-Based Materials

In addition to the cathode active materials previously mentioned, the cathode electrode may include other types of materials. For example, lithium iron phosphate (LiFePO4) may be used as a cathode active material due to its excellent thermal stability and long cycle life. Other phosphate-based materials such as lithium manganese iron phosphate (LiMnxFe1-xPO4), lithium vanadium phosphate (LiVOPO4), lithium titanium phosphate (LiTi2(PO4)3), lithium nickel phosphate (LiNiPO4), fluorophosphates such as LiVPO4F or LiFeSO4F, or lithium cobalt phosphate (LiCoPO4) may also be suitable.

### Layered Oxide Materials

The cathode active material may also include layered oxide materials with various compositions, such as Li(Ni1-x-yCoxMny)O2 (NCM) or Li(Ni1-x-yCoxAly)O2 (NCA), where the ratios of Ni, Co, Mn, and Al can be adjusted to optimize performance characteristics. For instance, NCM materials with high nickel content, such as NCM811 (LiNi0.8Co0.1Mn0.1O2), may be used to achieve higher energy density. In some cases, the cathode active material may comprise spinel structures like LiNi0.5Mn1.5O4, which can offer high voltage operation. Alternatively, materials with tavorite structures, such as LiFeSO4F or LiVPO4F, may be employed for their potential for high energy density and good thermal stability.

### Composite or Blended Cathode Materials

Composite or blended cathode materials, combining two or more active materials, may also be used. For example, a blend of layered oxides and spinel materials might be employed to balance energy density and power capability. As another example, lithium iron phosphate may be blended with one or more of the cathode active materials described above. In some embodiments, the cathode active material may include surface-modified versions of the aforementioned compounds, where the surface modification aims to improve stability, conductivity, or other performance metrics.

### Emerging Classes of Materials

The cathode active material may also include emerging classes of materials such as disordered rock salt structures (e.g., Li3NbO4-based materials), lithium-rich anti-perovskites (e.g., Li3OCl), cation-disordered oxides (e.g., Li—Mn—V—O systems), or high-entropy oxides, which may offer desirable combinations of high capacity and structural stability. In some cases, the cathode active material may incorporate dopants or substitutional elements to further tune its electrochemical properties.

### Particulate Nature of Cathode Active Material

The cathode active material can be particle shaped. The cathode active material can have a particle size in a range of from about 1 nm to about 1000 μm, such as about any of 10 nm, 20 nm, 30 nm, 40 nm, 50 nm, 60 nm, 70 nm, 80 nm, 90 nm, 100 nm, 110 nm, 120 nm, 130 nm, 140 nm, 150 nm, 160 nm, 170 nm, 180 nm, 190 nm, 200 nm, 210 nm, 220 nm, 230 nm, 240 nm, 250 nm, 260 nm, 270 nm, 280 nm, 290 nm, 300 nm, 310 nm, 320 nm, 330 nm, 340 nm, 350 nm, 360 nm, 370 nm, 380 nm, 390 nm, 400 nm, 410 nm, 420 nm, 430 nm, 440 nm, 450 nm, 460 nm, 470 nm, 480 nm, 490 nm, 500 nm, 550 nm, 600 nm, 650 nm, 700 nm, 750 nm, 800 nm, 850 nm, 900 nm, 950 nm, 1000 nm, 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 110 μm, 120 μm, 130 μm, 140 μm, 150 μm, 160 μm, 170 μm, 180 μm, 190 μm, 200 μm, 210 μm, 220 μm, 230 μm, 240 μm, 250 μm, 260 μm, 270 μm, 280 μm, 290 μm, 300 μm, 310 μm, 320 μm, 330 μm, 340 μm, 350 μm, 360 μm, 370 μm, 380 μm, 390 μm, 400 μm, 410 μm, 420 μm, 430 μm, 440 μm, 450 μm, 460 μm, 470 μm, 480 μm, 490 μm, 500 μm, 550 μm, 600 μm, 650 μm, 700 μm, 750 μm, 800 μm, 850 μm, 900 μm, 950 μm, or 1,000 μm. In embodiments, particle size of the cathode active material may be within a range formed by selecting any two numbers listed above or by selecting any two numbers in the range of from about 1 nm to about 1000 μm, e.g., between about 10 nm and about 1,000 μm. Gaps between cathode active material particles in the cathode electrode 102 can be filled with the solid electrolyte material.

### Amount of Cathode Active Material in Cathode Electrode

The amount of the cathode active material in the solid state battery 100 affects the charge and discharge capacity of the solid state battery 100. In order to manufacture a high-capacity cathode electrode 102, a high level of cathode active material can be included in the cathode electrode 102. For example, the cathode electrode 102 includes at, about, or greater than 1, 5, 10, 15, 20, 25, 30, 35, 40, 45, 50, 55, 60, 65, 70, 75, 80, 85, 90, 95, 98, or 99 wt % based on the total weight of the cathode electrode 102. In embodiments, cathode active material in the cathode electrode 102 may be within a range formed by selecting any two numbers listed above or by selecting any two numbers within the range from greater than 0 to about 100 wt %, e.g., between about 40 wt % and about 98 wt %.

### Conductive Material in Cathode Electrode

The conductive material in the cathode electrode 102 is not particularly limited, as long as it has conductivity while not causing any chemical change in the corresponding solid state battery 100. For example, the conductive material can comprise graphite, such as natural graphite or artificial graphite; carbon black, such as acetylene black, ketjen black, channel black, furnace black, lamp black or thermal black; conductive fibers, such as carbon fibers or metal fibers; carbon nanotubes (CNT), including both singled-walled carbon nanotubes (SWCNT) and multi-walled carbon nanotubes (MWCNT); metal powder, such as fluorocarbon, aluminum or nickel powder; conductive whiskers, such as zinc oxide or potassium titanate; conductive metal oxides, such as titanium oxide; conductive polymers, such as polyphenylene derivatives; graphene, metallic nanowires (e.g. silver nanowires), indium tin oxide (ITO), antimony-doped tin oxide (ATO), fluorine-doped tin oxide (FTO), aluminum-doped zinc oxide (AZO), gallium-doped zinc oxide (GZO), conductive ceramics like titanium nitride or titanium carbide, the like, or combinations thereof.

### Amount of Conductive Material in Cathode Electrode

The cathode electrode 102 includes at or about 1, 3, 4, 5, 6, 7, 8, 9, 10, 11, 12, 13, 14, 15,16, 17, 18, 19, 20, 21, 22, 23, 24, 25, 26, 27, 28, 29, or 30 wt % of conductive material based on the total weight of the cathode electrode 102. In embodiments, conductive material in the cathode electrode 102 may be within a range formed by selecting any two numbers listed in the immediately previous sentence, e.g., between about 1 wt % and about 30 wt %.

### Materials for Binder

The binder can comprise various types of binder polymers, such as, for example, polyvinylidene fluoride-co-hexafluoropropylene (PVdF-co-HFP), polyvinylidene fluoride, polyacrylonitrile, polymethyl methacrylate, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, polyacrylate, ethylene-propylene-diene monomer (EPDM), sulfonated EPDM, styrene butadiene rubber (SBR), fluororubber, polyacrylic acid, polyimide, polyamide-imide, polyurethane, polyethylene oxide (PEO), poly(ethylene-co-vinyl acetate) (PEVA), poly(vinyl acetate) (PVA), chitosan, guar gum (GG), xanthan gum, carrageenan, pectin, water-soluble polymers, lignin, polymers thereof whose hydrogen atoms are substituted with Li, Na or Ca, various copolymers thereof, the like, or combinations thereof.

### Other Binder Materials

In addition to the binder materials previously mentioned, other types of binder materials may be used in the cathode electrode to enhance its performance and stability. For instance, water-soluble binders such as sodium alginate, gelatin, or polyacrylamide may be employed to improve the environmental friendliness of the electrode manufacturing process. These binders may also offer advantages in terms of electrode flexibility and adhesion strength. In some cases, conductive binders like poly(3,4-ethylenedioxythiophene):poly(styrene sulfonate) (PEDOT:PSS) or polyaniline (PANI) may be used to simultaneously improve both the mechanical integrity and electrical conductivity of the electrode.

### Novel Binder Systems

Novel binder systems, such as self-healing polymers or supramolecular assemblies, may be incorporated to enhance the long-term stability and cycle life of the battery. Additionally, composite binders combining multiple polymers or incorporating inorganic nanoparticles may be utilized to tailor the mechanical, thermal, and electrochemical properties of the electrode. In some embodiments, bio-derived or biodegradable binders, such as cellulose derivatives or chitosan, may be employed to reduce the environmental impact of battery production and disposal.

### Amount of Binder in the Cathode Electrode

The cathode electrode 102 may include at or about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 wt % of binder based on the total weight of the cathode electrode 102. In embodiments, binder in the cathode electrode 102 may be within a range formed by selecting any two numbers listed in the immediately previous sentence, e.g., between about 1 wt % and about 30 wt %.

### Solid Electrolyte Material

The solid electrolyte material in the cathode electrode 102 can be configured the same as the material for the solid electrolyte layer 106 discussed below. The solid electrolyte material in the cathode electrode 102 can be the same as or different than the material for the solid electrolyte layer 106.

### Amount of Solid Electrolyte Material in Cathode Electrode

The cathode electrode 102 may include about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 wt % of solid electrolyte material based on the total weight of the cathode electrode 102. In embodiments, the amount of solid electrolyte material in the cathode electrode 102 may be within a range formed by selecting any two numbers listed in the immediately previous sentence, e.g., between about 1 wt % and about 30 wt %.

### Thickness of Cathode Electrode

A thickness, t₂, of the cathode electrode 102 can be at or about any number in a range of from greater than 0 to 1000 μm, such as 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400,410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, 1,000 μm. In embodiments, the thickness, t₂, of the cathode electrode 102 may be within a range formed by selecting any two numbers listed above or by selecting any two numbers within the range of from greater than 0 to about 1000 μm, e.g., between about 10 μm and about 1,000 μm.

### Porosity of Cathode Electrode

A porosity of the cathode electrode 102 can be at or about any number in a range of from 0 to 20 vol %, such as 0, 1, 2 3, 4, 5, 6, 7, 8, 9, 10, 11, 12, 13, 14, 15, 16, 17, or 18 vol % or any other vol % within the range of 0 to 20 vol %, based on the total volume of the cathode electrode 102. In embodiments, the porosity of the cathode electrode 102 may be within a range formed by selecting any two numbers listed above or by selecting any two numbers within the range of 0 to 20 vol %, e.g., between 0 vol % and about 18 vol %.

### Lithium Ion Diffusivity of Cathode Electrode

The cathode electrode 102 can include a lithium ion diffusivity at or about any number in a range of from greater than 0 to 1×10⁻⁷ cm²/s, such as 1×10⁻¹⁴ cm²/s, 1×10⁻¹³ cm²/s, 1×10⁻¹² cm²/s, 1×10⁻¹¹ cm²/s, 1×10⁻¹⁰ cm²/s, 1×10⁻⁹ cm²/s, 1×10⁻⁸ cm²/s, or 1×10⁻⁷ cm²/s. In embodiments, the lithium ion diffusivity of the cathode electrode 102 may be within a range formed by selecting any two numbers listed above or by selecting any two numbers within the range of from greater than 0 to 1×10⁻⁷ cm²/s, e.g., between 1×10⁻¹⁴ cm²/s and about 1×10⁻⁷ cm²/s.

### Current Collector at Cathode Electrode

The current collector 108 collects electrical energy generated at the cathode electrode 102 and supports the cathode electrode 102.

### Materials for Current Collector at Cathode Electrode

The material of the current collector 108 is not particularly limited as long as it allows adhesion of the cathode electrode 102, has a suitable electrical conductivity, and does not cause significant chemical changes in the corresponding solid state battery 100 in the voltage range of the solid state battery 100. For example, the current collector 108 is made of or includes various materials, such as, a metal, a conductive carbon, or a conductive ceramic, although not limited thereto. The metal of the current collector 108 may include one or more selected from the group consisting aluminum, an aluminum alloy, copper, a copper alloy, nickel, a nickel alloy, titanium, a titanium alloy, iron, an iron alloy (e.g., steel, stainless steel), silver, a silver alloy, gold, platinum, palladium, chromium, molybdenum, tungsten, tantalum, niobium, zirconium, vanadium, manganese, cobalt, indium, tin, lead, bismuth, or a combination thereof, although not limited thereto.

### Current Collector Geometry

The current collector 108 may also be configured in various other geometries to optimize its performance and integration with the cathode electrode 102, and may be sized for specific form factors, such as pouch, cylindrical, and/or prismatic form factors.

### Shape of Current Collector at Cathode Electrode

It is possible to increase the adhesion of the cathode electrode 102 to the current collector 108 by forming fine surface irregularities on the surface of the current collector 108. The current collector 108 may have various shapes, such as, for example, a film, a sheet, a foil, a net, a porous body, a foam, a non-woven web, the like, or combinations thereof.

### Examples of Shape and Size of Current Collector

For instance, the current collector 108 may be structured as a mesh or grid, which can provide enhanced mechanical support while maintaining high surface area for electrode adhesion. In some embodiments, the current collector 108 may be designed with a corrugated or wavy pattern, potentially increasing the contact area with the cathode material and improving overall conductivity. The current collector 108 may also be fabricated as a perforated sheet, allowing for better electrolyte penetration and ion transport. In certain cases, the current collector 108 may be formed as a three-dimensional structure, such as an interconnected network of fibers or a honeycomb-like configuration, which could enhance the structural integrity of the electrode assembly while facilitating efficient current collection.

### Thickness of Current Collector at Cathode Electrode

A thickness, t₃, of the current collector 108 can be at or about any number in a range of from greater than 0 to 500 μm, such as 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400,410, 420, 430, 440, 450, 460, 470, 480, 490, or 500 μm. In embodiments, the thickness, t₃, of the current collector 108 may be within a range formed by selecting any two numbers listed above or by selecting any two numbers within the range of from greater than 0 to 500 μm, e.g., between about 5 μm and about 500 μm.

### Manufacturing Methods for Cathode Electrode

The cathode electrode 102 may be obtained by various methods.

### Dry Powder Coating Process

For instance, a dry powder coating process may be employed, where the cathode active material, conductive additives, and binder are mixed in a dry state and then directly applied to the current collector 108 using electrostatic deposition or mechanical compression. This method may reduce environmental impact by reducing use of solvents.

### 3D Printing

In some cases, the cathode electrode 102 may be fabricated using additive manufacturing techniques such as 3D printing. This approach allows for precise control over the electrode structure and porosity, potentially enhancing the electrode's performance and energy density. Various 3D printing methods, including fused deposition modeling (FDM), selective laser sintering (SLS), or direct ink writing (DIW), may be utilized depending on the specific materials and desired electrode properties.

### Electrospinning

Another method for manufacturing the cathode electrode 102 may involve electrospinning. In this process, a solution containing the cathode active material, conductive additives, and a polymer binder is extruded through a nozzle under an electric field, resulting in the formation of nanofibers. These fibers can be collected directly on the current collector 108 to form a highly porous electrode structure with increased surface area.

### Tape Casting

In some embodiments, the cathode electrode 102 may be prepared using a tape casting method. This technique involves spreading a slurry of electrode materials onto a moving carrier film using a doctor blade, followed by drying and calendaring. The resulting electrode tape can then be laminated onto the current collector 108.

### Spray Coating

Alternatively, the cathode electrode 102 may be fabricated using a spray coating technique. In this method, a fine mist of the electrode slurry is sprayed onto the current collector 108 using compressed air or ultrasonic atomization. This approach may allow for the creation of thin, uniform electrode layers and can be particularly useful for large-scale production.

### Freeze-Casting

In certain cases, the cathode electrode 102 may be manufactured using a freeze-casting method. This process involves freezing a slurry of electrode materials, followed by sublimation of the ice to create a porous structure. The resulting porous electrode can then be sintered and attached to the current collector 108.

### Sol-Gel Process

For some applications, the cathode electrode 102 may be prepared using a sol-gel process. This method involves the formation of a colloidal suspension (sol) that is then converted into a gel-like network containing the cathode active material and other components. The gel can be applied to the current collector 108 and subsequently heat-treated to form the final electrode structure.

### Slurry-Based Process

For example, the cathode active material can be mixed and agitated with a solvent, and optionally a binder, conductive material, and a dispersing agent to form slurry. Then, the slurry can be applied (e.g., coated) onto the current collector 108, followed by pressing and drying, to obtain the cathode electrode 102.

### Application Methods for Slurry for Cathode Electrode

The application of the slurry to the cathode electrode 102 may include using a technique selected from the group consisting of slot die coating, gravure coating, spin coating, spray coating, roll coating, curtain coating, extrusion, casting, screen printing, inkjet printing, spray printing, gravure printing, heat transfer printing, a Toppan printing method, intaglio printing, offset printing, the like, and combinations thereof.

### Double Layer Slot Die Coating

In some embodiments, the cathode electrode 102 may be fabricated using a double layer slot die coating (DLD) technique. This method involves the simultaneous application of two distinct layers of electrode materials onto the current collector 108 in a single pass. The DLD process may allow for the creation of gradient structures within the electrode, potentially optimizing both the electrochemical performance and mechanical properties of the cathode. Additionally, this technique may enable the incorporation of functional interlayers or protective coatings as part of the electrode manufacturing process, potentially enhancing the overall battery performance and longevity.

### Solvent for Slurry for Cathode Electrode

The solvent for forming the cathode electrode 102 may include water and/or an organic solvents, such as, for example, N-methyl pyrrolidone (NMP), dimethyl formamide (DMF), acetone, dimethyl acetamide, dimethyl sulfoxide (DMSO), isopropyl alcohol, the like, or combinations thereof. The solvent may be used in an amount sufficient to dissolve and disperse the electrode ingredients, such as the cathode active material, binder, and conductive material, considering the slurry coating thickness, production yield, the like, or combinations thereof. Additional solvents that may be used include ethanol, methanol, propanol, butanol, ethyl acetate, methyl ethyl ketone, tetrahydrofuran, diethyl ether, and toluene.

### Solvent-Free Methods

In some aspects of the disclosure, the cathode electrode 102 may be prepared using a solvent-free method, such as dry powder processing or melt extrusion, which reduce the use of liquid solvents and may offer environmental and cost benefits.

### Dispersing Agent for Slurry for Cathode Electrode

The dispersing agent forming the cathode electrode 102 may include an aqueous dispersing agent and/or an organic dispersing agent, such as, for example, N-methyl-2-pyrrolidone. Other possible dispersing agents may include polyvinylpyrrolidone (PVP), carboxymethyl cellulose (CMC), sodium dodecyl sulfate (SDS), Triton X-100, polyethylene glycol (PEG), polyacrylic acid (PAA), and various surfactants such as polysorbates or poloxamers.

### Drying Technique for Slurry for Cathode Electrode

The slurry for the cathode electrode 102 may be dried by irradiating heat, electron beams (E-beams), gamma rays, or UV (G, H, I-line), the like, or combinations thereof, to vaporize the solvent. For example, the slurry may be vacuum dried at room temperature. Although the solvent is removed through evaporation by the drying step, the other ingredients do not evaporate and remain as they are to form the cathode electrode 102.

### Additional Drying Techniques

In addition to the drying techniques mentioned, the cathode electrode 102 may be dried using other methods such as infrared (IR) drying, microwave drying, or freeze-drying.

### Combination of Drying Techniques

In some embodiments, a combination of drying techniques may be employed, such as using convection heating followed by vacuum drying, to optimize the drying process and ensure complete solvent removal while maintaining the integrity of the electrode structure.

### Anode Electrode Generally

The anode electrode 104 is associated with one polarity (e.g., negative) of the solid state battery 100, which is different than the polarity of the cathode electrode 102. The anode electrode 104 is configured as a negative electrode during discharge of the solid state battery 100. The anode electrode 104 is suitable for lithium ion diffusion between a current collector 110 and the solid electrolyte layer 106.

### Anode Electrode Positioning

The anode electrode 104 is in electrical communication with the current collector 110. In embodiments, the anode electrode 104 is formed over and in direct contact with the current collector 110. In other embodiments, another functional layer may be interposed between the anode electrode 104 and the current collector 110.

### Anodeless Electrode System

In some embodiments, as explained above, the solid state battery 100 may utilize an anodeless electrode system. In such configurations, the anode electrode 104 may be omitted, and lithium metal may be deposited directly onto the current collector 110 during charging. This approach may potentially increase the energy density of the battery and eliminate a separate anode material, while also potentially reducing the overall thickness of the battery structure.

### Materials for Anode Electrode

The anode electrode 104 may be capable of reversible intercalation and deintercalation of lithium ions. For example, the anode electrode 104 can comprise an anode active material alone. In other examples, the anode electrode 104 may include conductive particles, a binder, the like, or combinations thereof.

### Additives for Anode Electrode

Optionally, the anode electrode 104 may further comprise an additive, such as, for example, an oxidation stabilizing agent (e.g., butylated hydroxyanisole, butylated hydroxytoluene, propyl gallate, tert-butylhydroquinone), a reduction stabilizing agent (e.g., ascorbic acid, sodium sulfite, erythorbic acid, sodium metabisulfite), a flame retardant (e.g., aluminum hydroxide, magnesium hydroxide, ammonium polyphosphate, melamine cyanurate), a heat or light stabilizer (e.g., phenolic compounds, phosphites, hindered amine light stabilizers, UV absorbers like benzophenones or benzotriazoles), an antifogging agent (e.g., polyethylene glycol, silica nanoparticles, glycerol, sorbitol), a thickener (e.g., carboxymethyl cellulose, xanthan gum), the like, or a combination thereof.

### Other Additives for Anode Electrode

Additionally, conductive additives such as carbon black, graphene, or carbon nanotubes may be incorporated to enhance electrical conductivity, while binder modifiers like styrene-butadiene rubber or polyacrylic acid may improve adhesion and mechanical stability. Functional additives such as fluoroethylene carbonate or vinylene carbonate may also be included to promote the formation of a stable solid electrolyte interphase layer on the anode surface.

### Materials for Anode Active Material

The anode active material is made of or includes various materials, such as, for example, an alkali earth metal, an alkaline earth metal, a group 3B metal, a transition metal, a metalloid, an alloy thereof, a conductive carbon, the like, or a combination thereof, although not limited thereof. In embodiments, the anode active material can comprise silicon, a silicon alloy, lithium, a lithium alloy, a conductive carbon, or a combination thereof, although not limited thereto. In embodiments, the lithium alloy is made of or includes a lithium alloy comprising silicon, chlorine, or a combination thereof. A lithium metal thin film may be used as the anode active material.

### Other Materials Anode Active Materials

The anode active material can include carbon-based material such as artificial graphite, natural graphite, graphitized carbon fiber, amorphous carbon or the like; a metallic compound capable of alloying with lithium such as Si, Al, Sn, Pb, Zn, Bi, In, Mg, Ga, Cd, a Si alloy, a Sn alloy, an Al alloy, or the like; a metal oxide capable of doping and dedoping lithium ions such as SiOₓ (0<x<2), SnO₂, vanadium oxide or lithium vanadium oxide; and a composite including the metallic compound and the carbon-based material such as a Si—C composite or a Sn—C composite.

### Carbon-Based Materials

The carbon-based material can include low-crystallinity carbon, high-crystallinity carbon, the like, or combinations thereof. A representative example of low-crystallinity carbon is soft carbon or hard carbon, and a representative example of the high-crystallinity carbon is high-temperature calcined carbon such as amorphous, platy, flaky, spherical or fibrous natural graphite or artificial graphite, kish graphite, pyrolytic carbon, mesophase pitch-based carbon fiber, meso-carbon microbeads, mesophase pitches, petroleum or coal tar pitch-derived coke, the like, or combinations thereof.

### Metal Carbon Composite Materials

Alternatively, according to aspects of the disclosure, the anode electrode 104 may comprise an anode material with a metal carbon composite, such as a silver-carbon blend or composite, where silver particles are complexed between amorphous and/or crystalline carbon particles. Here silver is used as an example, and other metals may be used, including for example, tin and/or zinc. Silicon can be used in place of the silver.

### Further Materials for Anode Active Material

In addition to the materials mentioned, the anode active material may also include titanium-based compounds such as lithium titanate (Li₄Ti₅O₁₂) or titanium dioxide (TiO2), which can offer excellent cycling stability and high-rate capability. Other potential materials may include transition metal oxides like molybdenum oxides (MoOx), iron oxides (FeOx), or nickel oxides (NiOx), which can provide high theoretical capacities. In some cases, composite materials combining different active materials, such as silicon-graphite composites or tin-carbon composites, may be used to leverage the advantages of multiple materials while mitigating their individual limitations.

### Dendrite Formation

When the anode electrode 104 is made of or includes lithium or a lithium alloy, dendrites may form on the anode electrode 104. The dendrites are a metallic lithium structure formed when extra lithium ions accumulate on a surface of the anode electrode 104. The formed dendrites may damage the solid electrolyte layer 106, reduce battery capacity of the solid state battery 100, and/or otherwise lead to undesired performance of the solid state battery 100. Dendrite formation is a significant challenge in lithium-based batteries, as these structures can grow through the electrolyte, potentially causing short circuits and safety hazards. The growth rate and morphology of dendrites may be influenced by factors such as current density, temperature, and the nature of the electrolyte-electrode interface.

### Advantages of Solid Electrolytes in Mitigating Dendrite Formation

Solid electrolytes offer several advantages over liquid electrolytes when it comes to mitigating dendrite formation. The mechanical strength of solid electrolytes may help suppress dendrite growth by providing a physical barrier to lithium metal penetration. Additionally, the uniform ion distribution in solid electrolytes may promote more even lithium deposition, reducing the likelihood of localized dendrite nucleation. Some solid electrolytes may also form a stable interface with the lithium metal anode, further inhibiting dendrite formation. However, while solid electrolytes can significantly reduce the risk of dendrite growth, they may not completely eliminate it, and ongoing research aims to develop advanced solid electrolyte materials with enhanced dendrite suppression capabilities.

### Shape of Anode Active Material

The anode active material can be particle shaped or it may be a continuous, unitary form (e.g., a thin film or sheet).

### Particle Size

In embodiments where the anode active material is particle shaped, the anode active material can comprise a particle size of any number in a range from at or about 10 nm to at or about 1000 μm, such as at or about 10 nm, 15 nm, 20 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm, 100 nm, 110 nm, 120 nm, 130 nm, 140 nm, 150 nm, 160 nm, 170 nm, 180 nm, 190 nm, 200 nm, 210 nm, 220 nm, 230 nm, 240 nm, 250 nm, 260 nm, 270 nm, 280 nm, 290 nm, 300 nm, 310 nm, 320 nm, 330 nm, 340 nm, 350 nm, 360 nm, 370 nm, 380 nm, 390 nm, 400 nm, 410 nm, 420 nm, 430 nm, 440 nm, 450 nm, 460 nm, 470 nm, 480 nm, 490 nm, 500 nm, 510 nm, 520 nm, 530 nm, 540 nm, 550 nm, 560 nm, 570 nm, 580 nm, 590 nm, 600 nm, 610 nm, 620 nm, 630 nm, 640 nm, 650 nm, 660 nm, 670 nm, 680 nm, 690 nm, 700 nm, 710 nm, 720 nm, 730 nm, 740 nm, 750 nm, 760 nm, 770 nm, 780 nm, 790 nm, 800 nm, 810 nm, 820 nm, 830 nm, 840 nm, 850 nm, 860 nm, 870 nm, 880 nm, 890 nm, 900 nm, 910 nm, 920 nm, 930 nm, 940 nm, 950 nm, 960 nm, 970 nm, 980 nm, 990 nm, 1000 nm, 2 μm, 3 μm, 4 μm, 5 μm, 6 μm, 7 μm, 8 μm, 9 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 110 μm, 120 μm, 130 μm, 140 μm, 150 μm, 160 μm, 170 μm, 180 μm, 190 μm, 200 μm, 210 μm, 220 μm, 230 μm, 240 μm, 250 μm, 260 μm, 270 μm, 280 μm, 290 μm, 300 μm, 310 μm, 320 μm, 330 μm, 340 μm, 350 μm, 360 μm, 370 μm, 380 μm, 390 μm, 400 μm, 410 μm, 420 μm, 430 μm, 440 μm, 450 μm, 460 μm, 470 μm, 480 μm, 490 μm, 500 μm, 510 μm, 520 μm, 530 μm, 540 μm, 550 μm, 560 μm, 570 μm, 580 μm, 590 μm, 600 μm, 610 μm, 620 μm, 630 μm, 640 μm, 650 μm, 660 μm, 670 μm, 680 μm, 690 μm, 700 μm, 710 μm, 720 μm, 730 μm, 740 μm, 750 μm, 760 μm, 770 μm, 780 μm, 790 μm, 800 μm, 810 μm, 820 μm, 830 μm, 840 μm, 850 μm, 860 μm, 870 μm, 880 μm, 890 μm, 900 μm, 910 μm, 920 μm, 930 μm, 940 μm, 950 μm, 960 μm, 970 μm, 980 μm, 990 μm, or 1,000 μm. In embodiments, particle size of the anode active material may be within a range formed by selecting any two numbers listed above or by selecting any two numbers in the range of from at or about 10 nm to at or about 1000 μm, e.g., between about 10 nm and about 1,000 μm.

### Amount of Anode Active Material in Anode Electrode

The amount of the anode active material in the solid state battery 100 affects the charge and discharge capacity of the solid state battery 100. In order to manufacture a high-capacity anode electrode 104, a high level of anode active material can be included in the anode electrode 104. For example, the anode electrode 104 includes at, about, or greater than 70, 80, 90, 95, 98, 99, or 100 wt % of anode active material based on the total weight of the anode electrode 104. In embodiments, anode active material in the anode electrode 104 may be within a range formed by selecting any two numbers listed in the immediately previous sentence, e.g., between about 70 wt % and about 100 wt %.

### Materials for Binder in Anode Electrode

The binder can comprise various types of binder polymers, such as, for example, polyvinylidene fluoride-co-hexafluoropropylene (PVdF-co-HFP), polyvinylidene fluoride, polyacrylonitrile, polymethyl methacrylate, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, polyacrylate, ethylene-propylene-diene monomer (EPDM), sulfonated EPDM, styrene butadiene rubber (SBR), fluororubber, polyacrylic acid, polymers thereof whose hydrogen atoms are substituted with Li, Na or Ca, various copolymers thereof, the like, or combinations thereof.

### Examples of Materials for Binder in Anode Electrode

In addition to the binders mentioned, other suitable binders for use in the anode electrode may include polyimide, polyamide-imide, polyurethane, polyethylene oxide (PEO), poly(ethylene-co-vinyl acetate) (PEVA), poly(vinyl acetate) (PVA), alginate, chitosan, guar gum, xanthan gum, carrageenan, pectin, gelatin, lignin, and various water-soluble polymers or their derivatives. In some cases, conductive polymers such as polypyrrole, polyaniline, or poly(3,4-ethylenedioxythiophene) (PEDOT) may also be used as binders to simultaneously improve adhesion and electrical conductivity within the anode electrode.

### Amount of Binder in Anode Electrode

The anode electrode 104 may include at or about 0, 1, 2, 3, 4, 5, 6, 7, 8, 9, 10, 11, 12, 13, 14, 15, 17, 18, 19, 20, 21, 22, 23, 24, 25, 26, 27, 28, 29, or 30 wt %, or any other wt % in the range between 0 and 30 wt % of binder based on the total weight of the anode electrode 104. In embodiments, binder in the anode electrode 104 may be within a range formed by selecting any two numbers listed above or by selecting any two numbers in the range between 0 and 30 wt %, e.g., between about 0 wt % and about 30 wt %.

### Thickness of Anode Electrode

The anode electrode 104 can have a thickness of at or about 10, 15, 20, 25, 30, 35, 40, 45, 50, 55, 60, 65, 70, 75, 80, 85, 90, 95, or 100 μm. In embodiments, the thickness, t₄, of the anode electrode 104 may be within a range formed by selecting any two numbers listed above or by selecting any two numbers in the range of from 10 μm to about 100 μm, e.g., between about 10 μm and about 100 μm or about 10 μm and about 20 μm.

### Porosity of Anode Electrode

A porosity of the anode electrode 104 can be about 0, 1, 2, 3, 4, 5, 6, 7, 8, 9, 10, 11, 12, 13, 14, 15, 16, 17, or 18 vol %, or any other vol % in the range from 0 to 18 vol %, based on the total volume of the anode electrode 104. In embodiments, the porosity of the anode electrode 104 may be within a range formed by selecting any two numbers listed above or by selecting any two numbers in the range from between 0 vol % to about 18 vol %.

### Lithium Ion Diffusivity of Anode Electrode.

The anode electrode 104 may include a lithium ion diffusivity of at or about 1×10⁻¹⁴ cm²/s, 1×10⁻¹³ cm²/s, 1×10⁻¹² cm²/s, 1×10⁻¹¹ cm²/s, 1×10⁻¹⁰ cm²/s, 1×10⁻⁹ cm²/s, 1×10⁻⁸ cm²/s, or 1×10⁻⁷ cm²/s. In embodiments, the lithium ion diffusivity of the anode electrode 104 may be within a range formed by selecting any two numbers listed above or by selecting any two numbers in the range from at or about 1×10⁻¹⁴ cm²/s to at or about 1×10⁻⁷ cm²/s.

### Current Collector at Anode Electrode

The current collector 110 collects electrical energy generated at the anode electrode 104 and supports the anode electrode 104.

### Materials for Current Collector at Anode Electrode

The material of the current collector 110 is not particularly limited as long as it allows adhesion of the anode electrode 104, has a suitable electrical conductivity, and does not cause significant chemical changes in the corresponding solid state battery 100 in the voltage range of the solid state battery 100. For example, the current collector 110 is made of or includes a metal or a conductive carbon, although not limited thereto.

### Metal for Current Collector

The metal of the current collector 110 may include one or more selected from the group consisting aluminum, an aluminum alloy, copper, a copper alloy, nickel, a nickel alloy, titanium, a titanium alloy, iron, an iron alloy (e.g., steel, stainless steel), silver, a silver alloy, or a combination thereof, although not limited thereto.

### Shape of Current Collector at Anode Electrode

It is possible to increase the adhesion of the anode electrode 104 to the current collector 110 by forming fine surface irregularities on the surface of the current collector 110. The current collector 110 may have various shapes, such as, for example, a film, a sheet, a foil, a net, a porous body, a foam, a non-woven web body, the like, or combinations thereof. In addition to the shapes mentioned, the current collector 110 may also be configured as a honeycomb structure, a perforated sheet, a woven or non-woven mesh, a sintered porous body, or a three-dimensional interconnected network. These various shapes can be tailored to optimize the surface area, mechanical strength, and current collection efficiency of the current collector 110.

### Design of Current Collector at Anode Electrode

Furthermore, the current collector 110 may be designed to accommodate different form factors of solid state batteries, such as pouch cells, cylindrical cells, or prismatic cells, each may offer advantages in terms of packaging efficiency, thermal management, and overall battery performance.

### Thickness of Current Collector at Anode Electrode

A thickness, t₅, of the current collector 110 can be at or about 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, or 500 μm. In embodiments, the thickness, t₅, of the current collector 110 may be within a range formed by selecting any two numbers listed above or by selecting any two numbers in the range of from at or about 1 μm to at or about 500 μm, e.g., between about 5 μm and about 500 μm.

### Manufacturing Methods for Anode Electrode

The anode electrode 104 may be obtained by various methods, such as, for example, atomic deposition, extrusion, rolling, a slurry method, or a combination thereof. In addition to the methods mentioned, the anode electrode 104 may be manufactured using various other techniques, including dry electrode processes. These alternative methods may offer advantages in terms of environmental impact, cost-effectiveness, and scalability.

### Dry Powder Coating

Dry powder coating may be employed as an alternative to the slurry method. In this process, the anode active material, conductive additives, and binder are mixed in a dry state and then directly applied to the current collector 110 using electrostatic deposition or mechanical compression. This method may reduce the use of solvents, potentially reducing environmental impact and processing time.

### 3D Printing

Additive manufacturing techniques, such as 3D printing, may be used to fabricate the anode electrode 104. Various 3D printing methods, including fused deposition modeling (FDM), selective laser sintering (SLS), or direct ink writing (DIW), can be utilized depending on the specific materials and desired electrode properties. This approach allows for precise control over the electrode structure and porosity.

### Electrospinning

Electrospinning is another potential method for manufacturing the anode electrode 104. In this process, a solution containing the anode active material, conductive additives, and a polymer binder is extruded through a nozzle under an electric field, resulting in the formation of nanofibers. These fibers can be collected directly on the current collector 110 to form a highly porous electrode structure with increased surface area.

### Tape Casting

Tape casting may be employed to prepare the anode electrode 104. This technique involves spreading a slurry of electrode materials onto a moving carrier film using a doctor blade, followed by drying and calendaring. The resulting electrode tape can then be laminated onto the current collector 110.

### Spray Coating

Spray coating techniques may be used to fabricate the anode electrode 104. A fine mist of the electrode slurry is sprayed onto the current collector 110 using compressed air or ultrasonic atomization. This approach may allow for the creation of thin, uniform electrode layers and can be particularly useful for large-scale production.

### Freeze-Casting

Freeze-casting is another potential method for manufacturing the anode electrode 104. This process involves freezing a slurry of electrode materials, followed by sublimation of the ice to create a porous structure. The resulting porous electrode can then be sintered and attached to the current collector 110.

### Sol-Gel Process

In some cases, a sol-gel process may be used to prepare the anode electrode 104. This method involves the formation of a colloidal suspension (sol) that is then converted into a gel-like network containing the anode active material and other components. The gel can be applied to the current collector 110 and subsequently heat-treated to form the final electrode structure.

### Vapor Deposition

For certain applications, physical vapor deposition (PVD) or chemical vapor deposition (CVD) techniques may be employed to create thin film anodes directly on the current collector 110. These methods can produce highly uniform and dense electrode layers, which may be particularly beneficial for certain types of solid-state batteries.

### Alloying and Ball Milling

Mechanical alloying and high-energy ball milling may be used to prepare composite anode materials, which can then be pressed into electrodes or applied to the current collector 110 using one of the aforementioned methods. This technique can be particularly useful for creating nanostructured or amorphous anode materials with enhanced electrochemical properties.

### Slurry Method

For example, the anode active material can be mixed and agitated with a solvent, and optionally a binder, and a dispersing agent to form slurry. Then, the slurry can be applied (e.g., coated) onto the current collector 110, followed by pressing and drying, to obtain the anode electrode 104.

### Application Methods for Slurry for Anode Electrode

The application of the slurry for the anode electrode 104 may include using a technique selected from the group consisting of slot die coating, gravure coating, spin coating, spray coating, roll coating, curtain coating, extrusion, casting, screen printing, inkjet printing, spray printing, gravure printing, heat transfer printing, a Toppan printing method, intaglio printing, offset printing, the like, and combinations thereof. In addition to the aforementioned techniques, other methods for applying the anode slurry to the current collector may include doctor blade coating, dip coating, and meniscus coating.

### Double Slot Die Layer Coating

Double slot die layer coating may also be employed, which allows for the simultaneous application of two distinct layers of electrode materials onto the current collector in a single pass. This method can potentially enable the creation of gradient structures within the electrode, optimizing both electrochemical performance and mechanical properties.

### Solvent for Slurry for Anode Electrode

The solvent for forming the anode electrode 104 may include water and/or an organic solvents, such as, for example, N-methyl pyrrolidone (NMP), dimethyl formamide (DMF), acetone, dimethyl acetamide, dimethyl sulfoxide (DMSO), isopropyl alcohol, the like, or combinations thereof. The solvent may be used in an amount sufficient to dissolve and disperse the electrode ingredients, such as the anode active material and binder, considering the slurry coating thickness, production yield, the like, or combinations thereof. Additional organic solvents that may be used include ethanol, methanol, propanol, butanol, ethyl acetate, methyl ethyl ketone, tetrahydrofuran, diethyl ether, and toluene.

### Solvent-Free Methods

In some embodiments, the anode electrode 104 may be prepared using a solvent-free method, such as dry powder processing or melt extrusion, which eliminates the need for liquid solvents and may offer environmental and cost benefits.

### Dispersing Agent for Slurry for Anode Electrode

The dispersing agent forming the anode electrode 104 may include an aqueous dispersing agent and/or an organic dispersing agent, such as, for example, N-methyl-2-pyrrolidone. Other examples of aqueous dispersing agents may include sodium dodecyl sulfate (SDS), polyvinylpyrrolidone (PVP), and carboxymethyl cellulose (CMC), while additional organic dispersing agents may include Triton X-100, polyethylene glycol (PEG), and various surfactants such as polysorbates or poloxamers.

Methods without a Dispersing Agent

In some embodiments, the anode electrode 104 may be prepared using methods that do not require a dispersing agent, such as dry powder processing or certain additive manufacturing techniques.

### Drying Technique for Slurry for Anode Electrode

The slurry for the anode electrode 104 may be dried by irradiating heat, electron beams (E-beams), gamma rays, or UV (G, H, I-line), the like, or combinations thereof, to vaporize the solvent. For example, the slurry may be vacuum dried at room temperature. Although the solvent is removed through evaporation by the drying step, the other ingredients do not evaporate and remain as they are to form the anode electrode 104.

### Other Drying Techniques

In addition to the drying techniques mentioned, several other methods may be employed to dry the anode electrode slurry. These additional techniques can offer various advantages depending on the specific materials, production requirements, and desired electrode properties.

### Infrared (IR) Drying

Infrared (IR) drying may be used to rapidly heat the electrode surface, promoting efficient solvent evaporation. This method can be particularly effective for thin electrode coatings and may allow for precise control of the drying process.

### Microwave Drying

Microwave drying is another option that can provide volumetric heating of the electrode material, potentially leading to more uniform drying throughout the electrode thickness. In some cases, a combination of convection and microwave drying may be employed to optimize both drying speed and uniformity.

### Freeze-Drying

Freeze-drying, also known as lyophilization, may be utilized for certain electrode formulations. This process involves freezing the slurry and then sublimating the solvent under vacuum conditions. Freeze-drying can help maintain the porous structure of the electrode, which may be beneficial for electrolyte penetration and ion transport.

### Supercritical CO2 Drying

Supercritical CO₂ drying is an advanced technique that may be employed for specialized electrode materials. This method involves replacing the solvent with liquid CO₂, which is then brought to its supercritical state and vented. This approach can help preserve delicate nanostructures within the electrode and may be particularly useful for aerogel-based electrodes.

### Two-Step Drying

In some cases, a two-step drying process may be employed. For example, initial drying may be performed at a lower temperature to remove bulk solvent, followed by a higher temperature step to remove residual solvent and potentially initiate any desired chemical reactions within the electrode material.

### Ultrasonic Drying

Ultrasonic drying may also be considered for certain electrode formulations. This technique uses high-frequency sound waves to agitate the solvent molecules, potentially accelerating the drying process and improving solvent removal from porous structures within the electrode.

### Solid Electrolyte Layer Generally

The solid electrolyte layer 106 is suitable for lithium ion diffusion between the cathode electrode 102 and the anode electrode 104. The solid electrolyte layer 106 provides an electrically conductive pathway for the movement of charge carriers between the cathode electrode 102 and the anode electrode 104. The solid electrolyte layer 106 is in electrical communication with the cathode electrode 102 and the anode electrode 104.

### Solid Electrolyte Positioning

In embodiments, the solid electrolyte layer 106 is formed over and in direct contact with the cathode electrode 102 or the anode electrode 104. In embodiments, the solid electrolyte layer 106 is in direct contact with the cathode electrode 102 and the anode electrode 104. In other embodiments, another functional layer may be interposed between the solid electrolyte layer 106 and the cathode electrode 102 and/or the anode electrode 104.

### Materials for Solid Electrolyte Layer

The solid electrolyte layer 106 may be capable of transport of lithium ions. The material of the solid electrolyte layer 106 is not particularly limited as long as it allows adhesion with adjacent layers, has a suitable electrical conductivity, and does not cause significant chemical changes in the corresponding solid state battery 100 in the voltage range of the solid state battery 100. For example, the solid electrolyte layer 106 may include various inorganic solid electrolytes, polymer solid electrolytes, and/or polymer gel electrolytes, although not limited thereto. Additionally or alternatively, the solid electrolyte layer 106 may include ceramic electrolytes, glass electrolytes, hybrid organic-inorganic electrolytes, and nanostructured electrolytes, although not limited to these categories.

### Inorganic Solid Electrolyte

The inorganic solid electrolyte may include a crystalline solid electrolyte, a non-crystalline solid electrolyte, a glass ceramic solid electrolyte, the like, or a combination thereof, although not limited thereto. The inorganic solid electrolyte may be sulfide-based, oxide-based, the like, or a combination thereof. In addition to sulfide-based and oxide-based inorganic solid electrolytes, other types of inorganic solid electrolytes may include halide-based electrolytes, nitride-based electrolytes, and borate-based electrolytes. For example, lithium-rich anti-perovskites (LiRAP) such as Li3OCl and Li3OBr, lithium nitride (Li3N), and lithium borohydride (LiBH4) have been investigated as potential solid electrolyte materials for lithium-ion batteries.

### Sulfide Based Solid Electrolyte

The sulfide-based solid electrolyte includes sulfur(S) and has ionic conductivity of metal belonging to Group I or Group II of the periodic table, and may include Li—P—S-based glass or Li—P—S-based glass ceramics.

### Examples of Sulfide-Based Solid Electrolyte

For example, the sulfide-based solid electrolyte may include lithium sulfide, silicon sulfide, germanium sulfide and boron sulfide. Particular examples of the inorganic solid electrolyte may include Li_{3.833}Sn_{0.833}AS_{0.166}S₄, Li₄SnS₄, Li_{3.25}Ge_{0.25}P_{0.75}S₄, Li₂S—P₂S₀, B₂S₃—Li₂S, XLi₂S-(100-x) P₂S₅ (x=70-80), Li₂S—SiS₂—Li₃N, Li₂S—P₂S₅—LiI, Li₂S—SiS₂—LiI, Li₂S—B₂S₃—LiI, Li₃N, LISICON, LIPON (Li_{3+y}PO₄₋ₓNₓ), thio-LISICON (Li_{3.25}Ge_{0.25}P_{0.75}S₄), Li₂O—Al₂O₃—TiO₂—P₂O₅ (LATP), Li₂S—P₂S₅, Li₂S—LiI—P₂S₅, Li₂S—LiI—Li₂O—P₂S₅, Li₂S—LiBr—P₂Ss, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SnS, Li₂S—P₂S₅—Al₂S₃, Li₂S—GeS₂, Li₂S—GeS₂—ZnS, Li₁₀GeP₂S₁₂ (LGPS), Li7P3S11, Li6PS5Cl, Li6PS5Br, Li6PS5I, Li9.54Si1.74P1.44S11.7Cl0.3, Li11Si2PS12, the like, or combinations thereof.

### Doped Variants

In some cases, doped variants of these materials, such as Al-doped Li10GeP2S12 or Sb-doped Li6PS5Cl, may also be employed to further enhance ionic conductivity or stability.

### Oxide Based Solid Electrolyte

The oxide-based solid electrolyte material contains oxygen (O) and has ionic conductivity of metal belonging to Group I or II of the periodic table.

### Examples of Oxide-Based Solid Electrolyte Material

The oxide-based solid electrolyte material may include at least one selected from the group consisting of LLTO-based compounds, Li₆La₂CaTa₂O₁₂, Li₆La₂ANb₂O₁₂ (A is Ca or Sr), Li₂Nd₃TeSbO₁₂, Li₃BO_{2.5}N_{0.5}, Li₉SiA₁O₈, LAGP-based compounds, LATP-based compounds, Li₁₊ₓTi₂₋ₓAlₓSi_{y} (PO₄)_{3-y} (0≤x≤1, 0≤y≤1), LiAlₓZr₂₋ₓ(PO₄)₃ (0≤x≤1, O≤y≤1), LiTiₓZr₂₋ₓ(PO₄)₃ (0≤x≤1, 0≤y≤1), LISICON-based compounds, LIPON-based compounds, perovskite-based compounds, NASICON-based compounds and LLZO-based or derived compounds (such as Al-doped Li7La3Zr2O12 and Ta-doped Li7La3Zr2O12). Lithium-rich anti-perovskites like Li3OCl and Li3OBr have also been investigated as potential oxide-based solid electrolytes.

### Composite Oxide Electrolyte

In some cases, composite oxide electrolytes combining multiple oxide materials, such as LLZO-LATP composites, may be employed to leverage the advantages of different oxide systems.

### Polymer Solid Electrolyte

The polymer solid electrolyte is a composite of electrolyte salt with polymer resin and has lithium ion conductivity. The polymer solid electrolyte may include a polyether polymer, a polycarbonate polymer, an acrylate polymer, a polysiloxane polymer, a phosphazene polymer, a polyethylene derivative, an alkylene oxide derivative, a phosphate polymer, a polyagitation lysine, a polyester sulfide, a polyvinyl alcohol, a polyvinylidene fluoride, a polymer containing an ionically dissociable group, poly(ethylene imine) (PEI), poly(methyl methacrylate) (PMMA), poly(acrylonitrile) (PAN), poly(ethylene succinate) (PES), biopolymers such as chitosan and cellulose derivatives, the like, or combinations thereof.

### Polymer Resin for the Solid Polymer Electrolyte

The solid polymer electrolyte may include a polymer resin, such as a branched copolymer including polyethylene oxide (PEO) backbone copolymerized with a comonomer including an amorphous polymer, such as, for example, PMMA, polycarbonate, polydiloxane (pdms) and/or phosphazene, comb-like polymer, crosslinked polymer resin, polyethylene glycol (PEG), polypropylene oxide (PPO), polyacrylonitrile (PAN), poly(methyl methacrylate) (PMMA), poly(vinylidene fluoride-co-hexafluoropropylene) (PVDF-HFP), poly(ethylene oxide-co-propylene oxide) (PEO-PPO), poly(ethylene imine) (PEI), poly(vinyl pyrrolidone) (PVP), poly(vinyl alcohol) (PVA), various block copolymers or graft copolymers incorporating these materials, the like, or combinations thereof.

### Polymer Gel Electrolyte

The polymer gel electrolyte can be formed by incorporating an organic electrolyte containing an organic solvent and an electrolyte salt, an ionic liquid, monomer, or oligomer to a polymer resin, the like, or combinations thereof. The polymer resin for the polymer gel can include polyether polymers, PVC polymers, PMMA polymers, polyacrylonitrile (PAN), polyvinylidene fluoride (PVDF), poly(vinylidene fluoride-co-hexafluoropropylene: PVDF-co-HFP), the like, or combinations thereof.

### Examples of Polymer Gel Electrolyte

Examples of polymer gel electrolytes that may be suitable for solid state batteries include poly(ethylene oxide) (PEO), poly(methyl methacrylate-co-ethyl acrylate) (PMMA-EA), poly(acrylonitrile-co-methyl methacrylate) (PAN-MMA), poly(vinyl acetate) (PVAc), poly(ethylene glycol diacrylate) (PEGDA), poly(vinyl pyrrolidone) (PVP), poly(ethylene glycol methyl ether acrylate) (PEGMEA), poly(ethylene glycol methyl ether methacrylate) (PEGMEMA), poly(ionic liquid) (PIL), poly(ethylene glycol-co-propylene glycol) (PEG-PPG), poly(vinyl alcohol-co-ethylene) (PVA-PE), poly(acrylamide) (PAM), poly(2-hydroxyethyl methacrylate) (PHEMA), poly(ethylene glycol-co-polyethylene oxide) (PEG-PEO), and poly(methacrylic acid) (PMAA) based gel electrolytes to optimize the electrochemical and physical properties of the solid electrolyte.

### Electrolyte Salt

The electrolyte salt is an ionizable lithium salt and may be represented by Li⁺X⁻. X⁻ may include an anion selected from the group consisting of F⁻, Cl⁻, Br⁻, NO₃⁻, N(CN)₂⁻, BF₄, ClO₄⁻, AlO₄⁻, AlCl₄⁻, PF₆⁻, SbF₆⁻, AsF₆⁻, BF₂C₂O₄⁻, BC₄O₈⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, C₄F₉SO₃⁻, CF₃CF₂SO₃⁻, (CF₃SO₂)₂N⁻, (F₂SO₂)₂N⁻, CF₃CF₂(CF₃)₂CO⁻, (CF₃SO₂)₂CH, CF₃ (CF₂)₇SO₃⁻, CF₃CO₂⁻, CH₃CO₂⁻, SCN⁻, (CF₃CF₂SO₂)₂N⁻, and the like.

### Examples of Lithium Salt

For example, the lithium salt may be any one selected from the group consisting of LiTFSI, LiCl, LiBr, LiI, LiClO₄, lithium tetrafluoroborate (LiBF₄), LiB₁₀Cl₁₀, lithium hexafluorophosphate (LiPF₆), LiAsF₆, LiSbF₆, LiAlCl₄, LiSCN, LiCF₃CO₂, LiCH₃SO₃, LiCF₃SO₃, LiN(SO₂CF₃)₂, LiN(SO₂C₂F₅)₂, LiC₄F₉SO₃, LiC(CF₃SO₂)₃, (CF₃SO₂)₂NLi, lithium chloroborate, lithium lower aliphatic carboxylate, lithium imide 4-phenylborate, lithium bis(oxalato)borate (LiBOB), lithium difluoro(oxalato)borate (LiDFOB), lithium bis(fluorosulfonyl)imide (LiFSI), lithium 4,5-dicyano-2-(trifluoromethyl)imidazolide (LiTDI), lithium bis(trifluoromethanesulfonyl)imide (LiTFSI), and lithium bis(fluorosulfonyl)imide (LiFSI), the like, and combinations thereof. The electrolyte salt can include any combination of the salts described herein.

### Amount of Electrolyte Salt

The solid electrolyte layer 106 can include at or about 0, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, or 400 parts, all based on the total weight of the solid electrolyte layer 106. In embodiments, electrolyte salt in the solid electrolyte layer 106 may be within a range formed by selecting any two numbers listed above or by selecting any two numbers between about 0 parts and about 400 parts, or about 60 parts and 400 parts, based on the total weight of the solid electrolyte layer 106.

### Ion Conductivity of Solid Electrolyte Layer

The solid electrolyte layer 106 may have a suitable reduction stability and/or ion conductivity. Since the solid electrolyte layer 106 mainly functions to transport lithium ions between electrodes, the solid electrolyte layer 106 can include a desirable ion conductivity of at, about, or greater than, for example, 10⁻⁷ S/cm, 10⁻⁶ S/cm, 10⁻⁵ S/cm, or 10⁻⁴ S/cm.

### Thickness of Solid Electrolyte Layer

A thickness, to, of the solid electrolyte layer 106 can be at or about 1, 2, 3, 4, 5, 6, 7, 8, 9, 10, 15, 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850,860, 870, 880, 890, 900, 910, 920, 930, 940, 950, 960, 970, 980, 990, or 1,000 μm. In embodiments, the thickness, to, of the solid electrolyte layer 106 may be within a range formed by selecting any two numbers listed above or by selecting any two numbers in the range of between 0 and at or about 1,000 μm, e.g., between about 5 μm and about 1,000 μm, about 30 μm and about 100 μm, or about 30 μm and about 50 μm.

### Unfinished Product

The cell 101 as shown in FIG. 13 can be provided as an unfinished product. In embodiments, the cell 101 is stored, transported, and/or delivered to a reseller, customer, or the like that finishes manufacture of a battery assembly or product comprising the cell 101. In other embodiments, the cell 101 is a finished battery assembly or product.

### Sealing Battery

An enclosure 112 of the solid state battery can be sealed to finish making the solid state battery 100 such that it will work as a battery. The sealing process may involve various techniques to ensure the internal components are protected from external environmental factors and to maintain the integrity of the battery structure. For example, the enclosure 112 may be hermetically sealed using methods such as laser welding, ultrasonic welding, or adhesive bonding. In some cases, the sealing process may also include the introduction of a protective atmosphere or the removal of air to create a vacuum within the enclosure. This sealing step may be helpful for preventing moisture ingress, which could potentially degrade the performance of the sulfide-based solid electrolyte. Additionally, the sealing process may incorporate safety features such as pressure relief mechanisms to manage any potential gas build-up during battery operation.

### After Sealing Battery

Once properly sealed, the solid state battery 100 is ready for final quality control checks, which may include electrical testing, leak detection, and visual inspections. After passing these checks, the solid state battery 100 could be packaged and sold as a finished product, ready for integration into various electronic devices, electric vehicles, energy storage systems, and so forth.

### Battery Configuration

The solid state battery 100 is provided in various configurations to suit different applications and device requirements. In some aspects, the battery may be manufactured in a cylindrical form, which can be advantageous for certain types of portable electronics or automotive applications. Alternatively, the solid state battery 100 may be produced in a prismatic form, which can allow for more efficient space utilization in devices with rectangular form factors. In other cases, a pouch form may be employed, offering flexibility in shape and potentially reducing overall battery weight. The pouch form may further be especially suitable for solid state batteries due to easier application and control of uniform pressures within the battery.

### Choice of Configuration

The choice of configuration may depend on factors such as the intended use, space constraints, thermal management requirements, and manufacturing considerations. In some embodiments, hybrid or custom configurations combining elements of different forms may be utilized as desired. The versatility in battery form factors can enable the integration of solid state batteries into a wide range of products, from small wearable devices to large-scale energy storage systems.

### Voltage

The solid state battery 100 is configured to output a voltage of at or about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 48, 50, 55, 60, 65, 70, 75, 80, 85, 90, 95, 96, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, or 500 V. In embodiments, the output voltage of the solid state battery 100 may be within a range formed by selecting any two numbers listed above or by selecting any two numbers in the range of between 0 and at or about 500 V, e.g., between about 1 V DC and about 500 V DC.

### Capacity

The solid state battery 100 may be configured to have a capacity of at, about, or greater than 100, 110, 120, 130, 140, 150, 160, 170, 180, 190, 200, 210, 220, 230, 240, 250, 260, 270, 280, 290, or 300 mAh/g. In embodiments, the output voltage of the solid state battery 100 may have a capacity formed by selecting any two numbers listed above or by selecting any two numbers in the range of between 0 and 300 mAh/g or between 0 and about 300 mAh/g, e.g., between about 100 mAh/g and about 300 mAh/g.

### Volume Expansion Calculation

The solid state battery 100 may be configured to have a desirable volume expansion rate. The volume expansion rate may be calculated from a change in thickness after the first cycle of charging and discharging compared to the initial thickness. The volume expansion rate may be a ratio of the thickness change to the initial thickness. A first cycle of charging and discharging is performed by CC-CV charging a battery at 0.1 C and cutting off at 4.25 to 4.4 V and 0.02 C, and CC discharging the battery at 0.1 C and cutting off at 3 V. The volume expansion rate is calculated by Equation 1 below in which A may represent a thickness before charging and discharging and B may represent a thickness after charging and discharging. The thickness may be measured using a Mauser micrometer or a scanning electron microscope (SEM).

$$Volume expansion rate = [ ( B - A ) / A ] \times 100 \qquad Equation 1$$

### C-Rate

C-rate as used herein refers to the rate at which the battery is discharged relative to its maximum capacity. For example, a 1C rate means the discharge current will discharge the entire battery within one hour. That is, for a battery with a capacity of 20 Amp-hrs, a discharge current at a 1C would be 20 Amps.

### Other Examples for Volumetric Expansion

Other ways to measure and calculate the volume expansion rate for a solid state battery may include using volumetric expansion measurement (e.g., gas pycnometry), in-situ dilatometry, X-ray tomography, strain gauge measurements, optical methods (e.g., digital image correlation or laser interferometry), pressure-based methods, and electrochemical strain microscopy.

### EXAMPLES

Examples will be described more fully hereinafter so that the present disclosure can be understood with ease. However, the following examples are for illustrative purposes only and the scope of the present disclosure is not limited thereto.

### Example 1

### Example 1.1: Inputs

The following input values are provided: CAM has a density of 4.7 g/cm\hat{ }3 and a Young's Modulus of 195 GPa. SE has a density of 1.74 g/cm\hat{ }3 and a Young's Modulus of 25 GPa. Binder and carbon have densities of 2.0 g/cm\hat{ }3, and their combined mass is 1% of the total mass. CAM has a normal distribution, where D5=3 μm, D50=4 μm, and D95=5 μm. SE has a distribution where D5=1 μm, D50=3 μm, and D95=7.8 μm.

### Example 1.2: Pre-Processing

Particle size distributions are created to match real-life experimental distributions. These particles are then randomly assorted within the simulation space, mimicking the real-life mixing process. To balance accuracy with computational efficiency, the experimental distribution is represented using 10 discrete sizes for each CAM and SE (e.g., LPSCI). Once the initial particle arrangement is set, LAMMPS' granular package is used to simulate the calendaring process. The total force (375 MPa multiplied by the simulation cross-section) is applied to the system and distributed proportionally based on the volume fraction of each component (CAM and SE). This force is then further divided between the CAM and SE particles. The inter-particle contact forces are calculated using LAMMPS' premade hertz/material granular contact, described by the following equation:

$${F}_{hertz / material} = \frac{4}{3} {E}_{eff} {R}^{\frac{1}{2}} {δ}_{ij}^{\frac{3}{2}} n \qquad ( 1 )$$

where Young's moduli (E) and radii (R) are effective, δᵢⱼ is overlap distance, and n is the normalized vector separating the two particle centers.

The simulation proceeds in discrete time steps. At each step, the sum of forces acting on each particle is calculated. Given the known mass of each particle, we then determine its resulting acceleration using a velocity-Verlet time integration scheme. To ensure numerical stability due to the explicit nature of the simulation, time steps of 5\hat{ }10\hat{ }−5 seconds (equivalent to 1/20000th of a second) are employed. The simulation continues until the microstructure reaches a settled state. At this point, particle data from the LAMMPS dump files is extracted. This data is then post-processed to analyze inter-particle connectivity, which allows determination of key metrics such as CAM utilization and tortuosity.

To account for the lack of plastic deformation in the Hertzian contact model, an overlap criterion is employed where “connected” particles must exceed an overlap of 2% of the sum of their radii to ensure adequate inter-particle contact.

To accurately represent the particle size distributions, 10 discrete sizes for each material are considered, and a cross-sectional area of 20 μm×20 μm is used for each simulation to balance model complexity and computational efficiency.

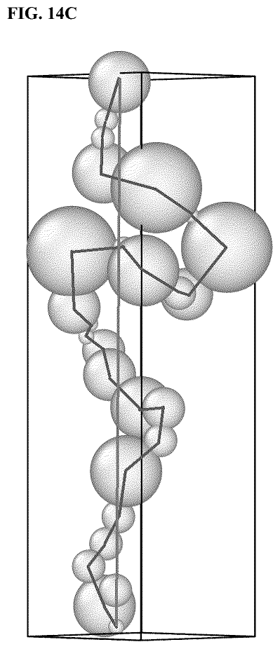

The target CAM content is set at 66%. The overlap criterion is set at 100%. The simulation model is iterated until the CAM content reaches the target CAM content. The pre-processing stage generates the particles in the simulation box as shown in FIG. 14A. The pressure used to press the simulation box is set at 375 MPa. The force is calculated 233638 pg·μm/μs² per CAM particle, and 315205 pg·μm/μs² per SE particle.

### Example 1.3: Processing

The processing stage generates the compressed simulation box as shown in FIG. 14B.

### Example 1.4: Post-Processing

The first objective evaluation is the CAM utilization, measured by calculating the percentage of CAM that has any overlap with the connected mass of SE in contact with the current collector. Secondly, the Li+ transport tortuosity of the LPSCI pathways in cathode composite is measured.

The CAM utilization is calculated 94%. The tortuosity is the ratio of the length of the tortuous pathway (red line) and the Euclidean distance (blue line) between particles on opposing sides, with a visualization shown in FIG. 14C. The tortuosity is calculated 1.86. The porosity is calculated 12.3%.

### Example 2

Example 1 is repeated 3 to 100 times (e.g., 10 times) with different input values to build a database of cathode compositions.

### Example 3

Examples 1-2 are repeated with different input values to build a database of anode compositions.

### Example 4

### Example 4.1: Selecting Cathode Composition

A cathode composition is selected from the databased built in Example 2.

### Example 4.2: Selecting Anode Composition

An anode composition is selected from the databased built in Example 3.

### Example 4.3: Making all-Solid-State Battery

An all-solid-state battery is made using the selected electrode compositions in Examples 4.1 to 4.2.

### Combinations and Characteristics Included

Various features and characteristics are described in this specification to provide an understanding of the composition, structure, production, function, and/or operation of the present disclosure, which includes the disclosed compositions, coatings, and methods. It is understood that the various features and characteristics of the present disclosure described in this specification can be combined in any suitable manner, regardless of whether such features and characteristics are expressly described in combination in this specification. The Inventors and the Applicant expressly intend such combinations of features and characteristics to be included within the scope of the present disclosure described in this specification. As such, the claims can be amended to recite, in any combination, any features and characteristics expressly or inherently described in, or otherwise expressly or inherently supported by, this specification. Furthermore, the Applicant reserves the right to amend the claims to affirmatively disclaim features and characteristics that may be present in the prior art, even if those features and characteristics are not expressly described in this specification. Therefore, any such amendments will not add new matter to the specification or claims and will comply with the written description, sufficiency of description, and added matter requirements.

### INCORPORATED BY REFERENCE

Any patent, publication, or other document identified in this specification is incorporated by reference into this specification in its entirety unless otherwise indicated but only to the extent that the incorporated material does not conflict with existing descriptions, definitions, statements, illustrations, or other disclosure material expressly set forth in this specification. As such, and to the extent necessary, the express disclosure as set forth in this specification supersedes any conflicting material incorporated by reference. Any material, or portion thereof, that is incorporated by reference into this specification but that conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference. The amendment of this specification to add such incorporated subject matter will comply with the written description, sufficiency of description, and added matter requirements.

### Illustration of Various Aspects

While the present disclosure provides descriptions of various specific aspects for the purpose of illustrating various aspects of the present disclosure and/or its potential applications, it is understood that variations and modifications will occur to those skilled in the art. Accordingly, the present disclosure herein should be understood to be at least as broad as claimed and not as more narrowly defined by particular illustrative aspects provided herein.

What is claimed is:

1. A method of making an all-solid-state lithium battery, the method comprising:
providing a set of input parameters comprising:
a weight percentage (SE_wt %) and a density (SE_density) of a solid electrolyte material (SE) comprising spherical SE particles, and
a weight percentage (EAM_wt %) and a density (EAM_density) of an electrode active material (EAM) comprising spherical EAM particles;
providing a volume percentage (EAM_vol) of the electrode active material and a volume percentage (SE_vol) of the SE as follows:
$$EAM\_vol = ( EAM\_wt \% / EAM\_density ) / ( EAM\_wt \% / EAM\_density + SE\_wt \% / SE\_density ) , \\ SE\_vol = ( SE\_wt \% / SE\_density ) / ( EAM\_wt \% / EAM\_density + SE\_wt \% / SE\_density ) ;$$
providing a probability value of the EAM as follows:
$$( EAM\_vol / EAM\_pvol ) / ( EAM\_vol / EAM\_pvol + SE\_vol / SE\_pvol ) ,$$
wherein EAM_pvol is a mean volume of the spherical EAM particles, and SE_pvol is a mean volume of the spherical SE particles, the probability value representing a number of the spherical SE particles for each spherical EAM particle;
using the probability value of the EAM to produce simulation box data representing a simulation box divided into discretized spaces, and the simulation box contains the spherical EAM particles and the spherical SE particles in randomly selected discretized spaces, and the simulation box data indicates whether each discretized space is occupied by one of the spherical EAM particle or one of the spherical SE particle;
processing the simulation box data to produce compressed simulation box data representing that the simulation box is compressed along a vertical axis between the top and the bottom without being compressed in any other direction, such that each of spherical EAM particles and the spherical SE particles touches at least one neighboring particle;
processing the compressed simulation box data to produce adjacency matrix data representing connected spherical SE particles, each of the connected spherical SE particles touching or overlapping with at least one adjacent spherical SE particle;
obtaining a relative tortuosity of the spherical SE particles inside the compressed simulation box, which comprises:
processing the adjacency matrix data to produce path data identifying paths generally in a direction from the top to the bottom through centers of the connected spherical SE particles, each path extending from a top connected spherical SE particle to a bottom connected spherical SE particle,
processing the path data to identify and store desired path data representing a desired path, and
extracting length data representing a length of the desired path from a center of a top connected spherical SE particle on the desired path to a center of a bottom connected spherical SE particle on the desired path;
extracting Euclidean distance data representing a Euclidean distance between the top connected spherical SE particle and the bottom connected spherical SE particle of the desired path; and
processing the length of the desired path and the Euclidean distance to provide the relative tortuosity;
repeating the above steps to prepare a database comprising sets of input parameters and corresponding relative tortuosities;
selecting a desired set of input parameters from the database using the corresponding relative tortuosity; and
preparing the all-solid-state lithium battery using the desired set of input parameters.

2. The method of claim 1, wherein the set of input parameters further comprises one or more of
particle size information of the spherical EAM particles, and
particle size information of the spherical SE particles,
a weight percentage and a density of a carbon material, and
a weight percentage and a density of a binder.

3. The method of claim 2, wherein the all-solid-state lithium battery comprises a first electrode, a second electrode, and an SE layer, the preparing the all-solid-state lithium battery comprising:
preparing the first electrode using the desired set of input parameters;
providing the second electrode;
providing the carbon material and the binder using the desired set of input parameters; and
preparing the SE layer using the desired set of input parameters.

4. The method of claim 2, wherein the particle size information of the spherical EAM particles comprises at least one of an average diameter or a particle size distribution of the spherical EAM particles.

5. The method of claim 2, wherein the particle size information of the spherical SE particles comprises at least one of an average diameter or a particle size distribution of the spherical SE particles.

6. The method of claim 1, wherein the set of input parameters comprises the particle size distribution of the spherical EAM particles and the particle size distribution of the spherical SE particles.

7. The method of claim 6 further comprising producing size data representing sizes of the spherical EAM particles and the spherical SE particles in the simulation box using the particle size distribution of the spherical EAM particles and the particle size distribution of the spherical SE particles.

8. The method of claim 6, wherein the particle size distribution of the spherical EAM particles and the particle size distribution of the spherical SE particles each are selected from the group consisting of normal, lognormal, skew normal, skew, and bimodal.

9. The method of claim 1, wherein the adjacency matrix data represents an adjacency matrix, wherein
the adjacency matrix is a Z×Z matrix, and Z is the number of the spherical SE particles;
the adjacency matrix data comprises a value of “1” in the adjacency matrix for each two adjacent spherical SE particles touching or overlapping with each other, wherein a sum of radii of the two adjacent spherical SE particles touching or overlapping with each other is equal to or greater than an overlap criterion; and
the adjacency matrix data comprises a value of “0” in the adjacency matrix for each two adjacent spherical SE particles not touching or overlapping with each other, wherein a sum of radii of the two adjacent spherical SE particles not touching or overlapping with each other is smaller than the overlap criterion.

10. The method of claim 9, wherein the overlap criterion is 100% to 105% of the Euclidean distance between the two adjacent spherical SE particles touching or overlapping with each other.

11. The method of claim 9, wherein the overlap criterion is 102% of the Euclidean distance between the two adjacent spherical SE particles touching or overlapping with each other.

12. The method of claim 1, wherein the set of input parameters comprises an additional input parameter selected from the group consisting of
at least one of Young's Modulus, Poisson's Ratio, Friction Coefficient, or Coefficient of Restitution of the SE material;
at least one of Young's Modulus, Poisson's Ratio, Friction Coefficient, or Coefficient of Restitution of the EAM;
a size of the simulation box;
a number of particles per edge of the simulation box; and
combinations thereof.

13. The method of claim 1, wherein the processing the simulation box data to produce the compressed simulation box data comprises processing pressure data representing a pre-determined pressure applied to the simulation box.

14. The method of claim 12 comprising calculating a total force applied to the simulation box by multiplying the pre-determined pressure by a cross-sectional area of the simulation box.

15. The method of claim 14 comprising calculating a force-per-particle, which comprises
dividing the total force into a first force on all the spherical EAM particles and a second force on all the spherical SE particles as follows:
$$the first force = the total force \times EAM\_vol , \\ the second force = the total force \times SE\_vol ;$$
dividing the first force by a total number of the spherical EAM particles, and
dividing the second force by a total number of the spherical SE particles.

16. The method of claim 1, wherein the EAM is a cathode active material.

17. The method of claim 3 further comprising calculating at least one of porosity of the first electrode, EAM utilization, or SE utilization.

18. The method of claim 1 further comprising calculating the EAM utilization, which comprises:
processing the adjacency matrix data to produce base SE data representing base connected spherical SE particles, wherein each of the base connected spherical SE particles touches or overlaps with an adjacent base connected SE particle, and at least one of the base connected spherical SE particles touches the bottom of the simulation box;
processing the adjacency matrix data to produce EAM data representing connected spherical EAM particles, wherein each of the connected spherical EAM particles touches at least one of the base connected spherical SE particles;
processing the EAM data to produce first volume data representing a total volume of the connected spherical EAM particles;
processing the simulation box data to produce second volume data representing a total volume of all the spherical EAM particles; and
dividing the total volume of the connected spherical EAM particles by the total volume of all the spherical EAM particles.

19. The method of claim 3 further comprising calculating porosity of the first electrode by
calculating a total volume of the first electrode by multiplying a pre-determined height of the simulation box by a cross-sectional area of the simulation box;
calculating a total volume of solids in the first electrode by adding a volume of the EAM and a volume of the SE material;
calculating a volume of voids by subtracting the total volume of solids from the total volume of the first electrode; and
dividing the volume of voids by the total volume of the first electrode.

20. An electric vehicle comprising the all-solid-state battery made by the method of claim 1.
